(19) United States
(12) Patent Application Publication
(10) Pub. No.: US 2026/0309979 A1
(43) Pub. Date: Oct. 8, 2026

(54) DEVICES TO DIRECT THE PATH OF ELECTROMAGNETIC RADIATION

(71) Applicant: CORNING INCORPORATED, CORNING, NY (US)

(72) Inventor: Paulo Clovis Dainese, Jr., Painted Post, NY (US)

(21) Appl. No.: 19/479,921

(22) PCT Filed: May 17, 2024
(86) PCT No.: PCT/US2024/029821

§ 371 Date: Oct. 29, 2025

Related U.S. Application Data
(60) Provisional application No. 63/472,858, filed on Jun. 14, 2023.

(51) Int. Cl. G02B 27/00; G02B 1/00

(52) U.S. Cl. CPC G02B 27/0012; G02B 1/002

(57) ABSTRACT

Implementations are described to determine designs for devices that modify electromagnetic radiation incident upon the devices. In one or more examples, the designs can include arrangements of structures that are configured to perform one or more functions, such as beam steering, polarization state change, refraction, reflection, one or more combinations thereof, and the like. The designs can be generated using a metasurface design optimization process that includes a number of iterations with an efficiency of subsequent iterations of the metasurface design optimization process increasing with respect to at least one previous iteration.

### CROSS-REFERENCE TO RELATED APPLICATIONS

This application claims the benefit of priority under 35 U.S.C. § 119 of U.S. Provisional Application Ser. No. 63/472,858 filed on Jun. 14, 2023, the content of which is relied upon and incorporated herein by reference in its entirety.

### TECHNICAL FIELD

Implementations are directed to computational processes for designing devices having structures arranged in a layout that modifies electromagnetic radiation incident upon the structures.

### BACKGROUND

Electromagnetic radiation incident upon a device having an array of structures can be modified for a number of reasons. For example, the path of the electromagnetic radiation can be directed along a modified path after contacting the device. In illustrative scenarios, the device can be used in beam steering scenarios and/or to direct the electromagnetic radiation toward a receiver device. Additionally, devices having an array of structures can be used to produce a desired phase and amplitude response with respect to incident electromagnetic radiation. In still other examples, devices having an array of structures can be used to produce at least one of a desired polarization response or a desired angular momentum response with respect to electromagnetic radiation incident upon the devices.

### BRIEF DESCRIPTION OF THE DRAWINGS

FIG. 1 illustrates a framework for designing metasurfaces, in accordance with one or more example implementations.

FIG. 2 illustrates a framework to modify boundaries of structures of a metasurface design, in accordance with one or more example implementations.

FIG. 3 illustrates a sequence showing modifications to boundaries of structures included in a design of a metasurface, in accordance with one or more example implementations.

FIG. 4 illustrates a flowchart of an example process to generate metasurface designs, in accordance with one or more example implementations.

FIG. 5 is a block diagram illustrating components of a machine, in the form of a computer system, that may read and execute instructions from one or more machine-readable media to perform any one or more methodologies described herein, in accordance with one or more example implementations.

FIG. 6 is block diagram illustrating a representative software architecture that may be used in conjunction with one or more hardware architectures described herein, in accordance with one or more example implementations.

FIG. 7 illustrates efficiencies generated during optimization of a dual-polarization 40-degree beam deflector performed using electromagnetic radiation having a wavelength of 1550 nanometers.

FIG. 8 illustrates a comparison of efficiencies of a metasurface design of a beam deflector at an arbitrary angle for two polarization states with the optimization being performed using electromagnetic radiation having a wavelength of 1550 nanometers.

FIG. 9 illustrates efficiencies of metasurfaces designed using different methodologies and at different polarization states at a number of deflection angles with the optimization being performed using electromagnetic radiation having a wavelength of 1550 nanometers.

FIG. 10 illustrates shape optimization of two metalenses performed using electromagnetic radiation having a wavelength of 1550 nanometers that were initially designed using different libraries.

FIG. 11 illustrates shape optimization of a metalens performed using electromagnetic radiation having a wavelength of 1550 nanometers that was initially designed using the library approach.

### DETAILED DESCRIPTION

The following description and the drawings sufficiently illustrate specific implementations to enable those skilled in the art to practice them. Other implementations may incorporate structural, logical, electrical, process, and other changes. Portions and features of some implementations may be included in, or substituted for, those of other implementations. Implementations set forth in the claims encompass all available equivalents of those claims.

Devices having arrays of structures that are configured to modify characteristics of an electromagnetic radiation field can include metasurfaces. Metasurfaces can include an arrangement of structures, where the structures have dimensions that are sub-wavelength with respect to electromagnetic radiation included in the field up to a multiple of the wavelengths of electromagnetic radiation included in the field. Metasurfaces can include periodic or non-periodic arrangements of features to perform one or more relatively basic optical functions, such as focusing and deflection, as well as perform more complex optical functions, such as polarization imaging, broadband imaging, dispersion engineering, mode multiplexing, and others.

Metasurfaces provide flexibility and diversity in the control of electromagnetic radiation field response in relation to other techniques for tailoring electromagnetic radiation field response. For example, rather than using a single metasurface to provide both refraction and polarization functions, many optical response technologies implement different technology platforms to implement each type of functionality, such as providing a lens with a given curvature to produce a desired amount of refraction and a waveplate to achieve a desired polarization state. In this way, metasurfaces can integrate multiple optical procedures into a single device and reduce the size and cost of a device that can be used to perform one or more optical functions.

Existing techniques to design metasurfaces can include a library technique that implements a library of structures with pre-existing shapes to use to design a metasurface. The number of parameters that are modified for the structures in a library are often limited. For example, parameters of the structures included in a library can include radius of circular shapes or number of sides of a polygon. Libraries of metasurface structures can be directed to specific applications. To illustrate, libraries can be generated for metasurfaces used in waveguide arrays and other libraries can be generated for metasurfaces that implement effective medium theory. Typically, designing metasurfaces using a library of structures does not properly take into account interactions between structures because metasurfaces using libraries of structures are designed based on the individual structures being isolated in space or based on the structures being included in a uniform array of identical structures. Neither of these assumptions capture the real-world behavior of the entire metasurface array. Additionally, libraries of structures are designed with respect to a specific set of conditions, such as angle of incidence, electromagnetic radiation wavelength, polarization state, etc. However, in situations where a metasurface is to be designed to operate under conditions different from those under which the library was designed, the performance of the actual metasurface may be diminished with respect to the performance of a metasurface that operates under the same conditions or similar conditions from which the library was designed. Further, metasurfaces structure libraries are not designed to handle complex wavefronts and are often restricted to planar wave input. In scenarios where metasurfaces are to be designed to operate under a number of different conditions, such as multiple incident wavelengths, or implement multiple functionalities, such as diffraction and different polarization states, the complexity of building and combining multiple libraries that accomplish each of the functions of the metasurface can lead to decreased performance of the metasurface or lead to a reduction in the amount of functionality provided by the metasurface.

In some additional situations, metasurfaces can be designed using a topology optimization approach that is used to generate an arrangement of structures of a metasurface where the individual structures can have arbitrary geometries and does not utilize structures having predetermined shapes, as in the library approach. In contrast, the topology optimization approach utilizes an initial arrangement of structures having a randomly generated refractive index profile. The complexity of metasurface designs can be difficult to control because the topology of the domain can vary with each iteration. For example, structures of metasurfaces designed using a topology optimization approach can have features, such as holes, sharp edges, and highly irregular boundaries, that can lead to difficult manufacturing metasurfaces designed using a topology optimization approach. When using topology optimization techniques, the efficiency of a metasurface can begin to decrease. In these situations, secondary techniques are implemented that are outside of the primary topology optimization algorithm to modify the metasurface structures and increase the efficiency of the metasurface. After modification of the metasurface structures, the primary topology optimization algorithm is resumed. The use of secondary/offline procedures to simplify the structures, such as image filtering, can be enforced at the expense of performance penalty when applied, requiring further optimization afterwards. Additionally, because of the amount of variation possible in metasurface structure features when a topology optimization approach is implemented and due to the randomly generated features used as an initial starting point used by topology optimization approaches, the topology optimization approach often converges to a metasurface feature design that represents a sub-optimum performance. Typically, the topology optimization approach utilizes many optimization runs under different conditions in order to generate metasurface designs that have a relatively high efficiency. As a result, the amount of time and computing resources used to generate metasurface designs using topology optimization approaches can be prohibitive.

In implementations described herein, structures of metasurfaces are designed using computational techniques that enables larger control of the complexity of the structures with no need for offline simplification procedures. The final structures are often easier to manufacture than metasurfaces designed using previously implemented techniques. In addition, the method does not require initialization with random refractive index distribution. Instead, initial guesses with relatively good performance enables fewer computing resources than previously implemented methods. Additionally, metasurface designs can be generated that are configured to perform multiple functions, which is in contrast to previously implemented metasurface design approaches, such as the library approach.

In one or more examples, an initial arrangement of structures of a metasurface can be generated that have a predetermined shape. The structures included in the initial arrangement can also have predetermined dimensions. In at least some examples, the dimensions of the structures of a metasurface design can be on the order of wavelengths incident upon the metasurface or the dimensions of the structures can be a fraction of the wavelengths incident upon the metasurface. In at least some examples, the initial arrangement of structures of a metasurface can be produced using a library of predetermined metasurface structures. In various examples, the boundaries of the structures of the initial arrangement of structures can be modified in an iterative process until the efficiency of the metasurface has been optimized with respect to a target electromagnetic radiation field. The target electromagnetic radiation field can correspond to a desired functionality of the metasurface. For example, a desired functionality of the metasurface can correspond to deflection of a range of wavelengths of an incident electromagnetic radiation field to produce a given angle of deflection for the range of wavelengths. In these situations, the target electromagnetic radiation field can correspond to the deflection of an incident electromagnetic radiation field at the desired angle with at least a threshold efficiency, such as at least 90% efficiency, at least 95% efficiency, or at least 99% efficiency.

The iterative process can include, for a given arrangement of structures, performing one or more simulations that propagate one or more fields of electromagnetic radiation through the structures. In one or more examples, for a given arrangement of structures, a forward electromagnetic radiation field can be propagated through the structures. Additionally, an adjoint electromagnetic radiation field can be propagated through the structures. The adjoint field can correspond to propagation of a target electromagnetic radiation field backwards through the metasurface. The electromagnetic radiation fields produced in response to the forward electromagnetic radiation field and to the adjoint electromagnetic radiation field can be analyzed to determine an efficiency of a given arrangement of structures. The boundaries of the structures of the arrangement can be modified and the simulations that include the propagation of the forward electromagnetic radiation field and the adjoint electromagnetic radiation field can be repeated and the efficiency of a current arrangement of structures can be determined. Modifications to the boundaries of the structures and performing the simulations including the forward electromagnetic radiation fields and the adjoint electromagnetic radiation fields can be repeated until an optimized efficiency for a metasurface with respect to a target electromagnetic radiation field is achieved or until a local maximum of the efficiency is obtained.

In various examples, the structures included in the metasurface design produced according to implementations described herein can individually have shapes and dimensions that are different from other structures included in the metasurface design. Additionally, modifications to the boundaries of the structures can be limited such that with each iteration, the structures correspond to one or more criteria. For example, in one or more implementations described herein, changes to the boundaries of the structures can be limited such that an amount of roundness to the edges of the structures is maintained with each iteration of the process. Modifications to the boundaries of the structures can also be limited to modifications that do not produce holes or other gaps within the interior of the structures. In one or more examples, a decomposition process can be applied to operations used to determine the changes to the boundaries of the structures in order to limit the changes to the boundaries of the structures. In one or more illustrative examples, the order of coefficients of a Fourier decomposition process used in relation to modifying the boundaries of the structures can be limited to control the changes to the boundaries of the structures. In contrast to the use of offline structure simplification procedures by topology optimization techniques, which often lead to a significant drop in the efficiency, implementations described herein do not decrease the efficiency when applied. Rather, with each successive iteration of the metasurface design optimization process, the efficiency is at least the value of the efficiency of a previous iteration.

The techniques, methods, systems, and devices described herein take into account interactions between structures of metasurfaces and to make a greater range of changes to characteristics of the structures than some existing technologies. As a result, the metasurfaces designed according to implementations described herein can have an optimal combination of efficiency and manufacturability in relation to previous metasurface design techniques. Additionally, the flexibility in the characteristics of the metasurface structures provided by the implementations described herein can be used to design metasurfaces that can provide multiple functionalities and achieve efficiencies for each of the functionalities that are greater than previously implemented techniques. Further, by limiting the extent of the modifications to the boundaries of the structures and by using an initial shape for the optimization process that has a minimum efficiency, the techniques described herein can be implemented using fewer computational resources than existing technologies and can converge at greater efficiencies.

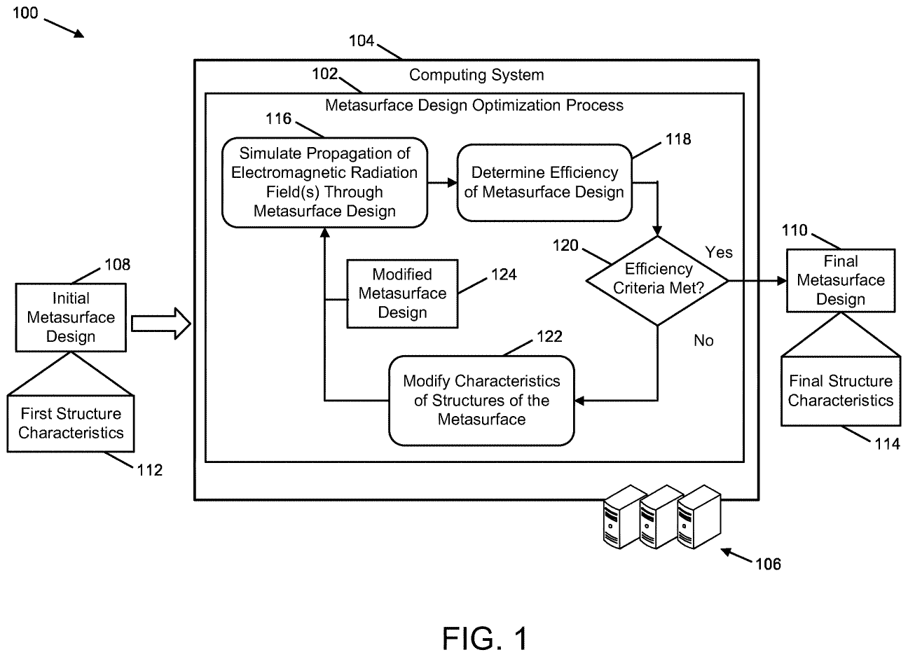

FIG. 1 illustrates a framework 100 for designing metasurfaces, in accordance with one or more example implementations. The framework 100 can include a metasurface design optimization process 102. The metasurface design optimization process 102 can be implemented to determine an arrangement of structures for a metasurface that is configured to provide one or more functions with respect to electromagnetic radiation incident on the structures of the metasurface. The metasurface design optimization process 102 can be implemented by a computing system 104 that includes one or more computing devices 106. The one or more computing devices 106 can include one or more server computing devices, one or more desktop computing devices, one or more laptop computing devices, one or more tablet computing devices, one or more mobile computing devices, or combinations thereof. In one or more implementations, at least a portion of the one or more computing devices 106 can be implemented in a distributed computing environment. For example, at least a portion of the one or more computing devices 106 can be implemented in a cloud computing architecture.

In one or more examples, the metasurface design generated using the metasurface design optimization process 102 can be configured to provide beam steering functionality. In one or more additional examples, the metasurface design can be configured to provide refraction functionality. For example, the metasurface design can be configured to provide metalense functionality. In one or more further examples, the metasurface design can be configured to produce electromagnetic radiation having a specified polarization state. In still other examples, the metasurface design can be configured to provide diffraction functionality. The metasurface design can also be configured to provide waveguide functionality. In various examples, the metasurface design can be configured to provide functionality that corresponds to the functionality of birefringement crystals. In at least some examples, the metasurface design can be configured to provide functionality that corresponds to effective medium theory. The metasurface design can be configured to provide at least one of beam steering functionality, refraction functionality, metalense functionality, polarization state functionality, diffraction functionality, waveguide functionality, birefringement crystal functionality, magnification functionality, beam splitting functionality, or effective medium theory functionality. Metasurfaces designed using the metasurface design optimization process 102 can be implemented in one or more technologies, such as wireless communications, lasers, polarization imaging, broadband imaging, dispersion engineering, mode multiplexing, hyper-spectral imaging, micro-electro-mechanical systems, light emitting devices, one or more combinations thereof, and the like.

Electromagnetic radiation fields incident upon the implementations of metasurfaces described herein can have wavelengths from about 50 nanometers (nm) to about 100 millimeters (mm), from about 100 nm to about 10000 nm, from about 100 nm to about 2000 nm, from about 300 nm to about 1000 nm, from about 1000 nm to about 2000 nm, from about 5 micrometers (μm) to about 50 mm, from about 1 μm to about 100 μm, from about 100 μm to about 500 μm, from about 500 μm to about 5 mm, from about 1 mm to about 100 mm, or from about 1 mm to about 50 mm. Additionally, electromagnetic radiation fields incident upon implementation of metasurfaces described herein can be complex and may not be a planar electromagnetic radiation field. For example, one or more metasurfaces designed according to the metasurface design optimization process 102 can be formed to direct electromagnetic radiation to multiple, different destinations, such as in a multi-core fiber.

In one or more examples, metasurfaces designed according to the metasurface design optimization process 102 can be formed from a number of different materials. In various examples, the materials, sizes, and other characteristics of the metasurfaces can be based on one or more functionalities for which the metasurfaces are to be used. The metasurfaces can include a number of structures that are formed on a substrate. In at least some examples, the metasurfaces can be formed as part of one or more layers of a substrate. For example, the metasurfaces can be arranged in a stack within a substrate. In one or more additional examples, a first metasurface can be formed on a first surface of a substrate and a second metasurface can be formed on a second surface of a substrate. The metasurfaces designed using the metasurface design optimization process 102 can be incorporated into additional devices or systems that utilize the functionality provided by the metasurfaces.

The metasurface design optimization process 102 can use an initial metasurface design 108 as an input and generate a final metasurface design 110 as an output. The initial metasurface design 108 can include first structure characteristics 112 and the final metasurface design 110 can include final structure characteristics 114. In one or more examples, the first structure characteristics 112 can indicate characteristics of individual structures of the initial metasurface design 108 and the final structure characteristics 112 can indicate characteristics of individual features of the final metasurface design 110. In one or more additional examples, the first structure characteristics 112 can indicate characteristics of one or more groups of structures of the initial metasurface design 108 and the final structure characteristics 114 can indicate characteristics of one or more groups of structures of the final metasurface design 110. In one or more illustrative examples, the first structure characteristics 112 can indicate respective locations of individual structures of the initial metasurface design 108 and the final structure characteristics 114 can indicate respective locations of individual structures of the final metasurface design 110. In various examples, during the metasurface optimization process 102, one or more intermediate metasurface designs can be generated between the initial metasurface design 108 and the final metasurface design 110. The structures of the intermediate metasurface designs can have characteristics that correspond to at least one of the first structure characteristics 112 or the final structure characteristics 114 and/or that have values that are in between the values of the first structure characteristics 112 and the final structure characteristics 114.

In one or more examples, the structures included in at least one of the initial metasurface design 108 or the final metasurface design 110 can be arranged in a periodic array. For example, the distances between individual structures of the initial metasurface design 108 and/or the final metasurface design 108 can be the same or approximately the same. To illustrate, a distance between one or more first structures and one or more second structures of the initial metasurface design 108 and/or the final metasurface design 110 can be within a tolerance of ±1%, ±2%, ±3%, ±5%, or ±10%. In one or more additional examples, the structures included in at least one of the initial metasurface design 108 or the final metasurface design 110 can be arranged in an aperiodic array. That is, the distances between structures included in the initial metasurface design 108 and the final metasurface design 110 can be irregular. In one or more illustrative examples, the distances between structures included in at least one of the initial metasurface design 108 or the final metasurface design 110 can be from about 0.5 nm to about 500 μm, from about 0.5 nm to about 100 nm, from about 100 nm to about 1 μm, from about 1 μm to about 100 μm, from about 50 μm to about 250 μm, from about 100 μm to about 500 μm, from about 1 μm to about 500 μm, from about 10 nm to about 100 nm, or from about 1 nm to about 50 nm. In one or more additional illustrative examples, the dimensions of the structures and/or the distances between structures can correspond to the wavelength of electromagnetic radiation incident on the metasurface. In this way, as the values of the wavelengths incident upon the metasurfaces increases, the dimension of the structures of the metasurface and/or the distances between the structures of the metasurface can also increase. Additionally, as the values of the wavelengths incident upon the metasurfaces decreases, the dimension of the structures of the metasurface and/or the distances between the structures of the metasurface can also decrease.

Additionally, the first structure characteristics 112 can indicate materials of one or more structures of the initial metasurface design 108 and the final structure characteristics 114 can indicate materials of one or more structures of the final metasurface design 110. In at least some examples, a first portion of the structures of the initial metasurface design 108 can include one or more first materials and a second portion of the structures of the initial metasurface design 108 can include one or more second materials with at least one second material of the one or more second materials being different from at least one first material of the one or more first materials. Materials of different structures included in the final metasurface design 110 can also be different with one or more first structures included in the final metasurface design 110 including one or more materials that are different from one or more second structures included in the final metasurface design 110. Additionally, structures of the initial metasurface design 108 can be comprised of one or more materials that are different from one or more materials of structures of the final metasurface design 110.

At least one of the first structure characteristics 112 or the final structure characteristics 114 can also indicate shapes of structures included in at least one of the initial metasurface design 108 or the final metasurface design 110 and dimensions of shapes included in at least one of the initial metasurface design 108 or the final metasurface design 110. In at least some examples, the shapes can be defined by one or more boundaries. In addition, the boundaries can be closed. In one or more additional examples, structures of the initial metasurface design 108 can have one or more open boundaries that are closed in the final metasurface design 110. In various examples, structures of at least one of the initial metasurface design 108 or the final metasurface design 110 can have boundaries with a number of segments.

The boundaries can also have a measure of roundness. In at least some examples, structures of at least one of the initial metasurface design 108 or the final metasurface design 110 can have one or more segments having a measure of roundness and one or more additional segments that are relatively straight. In one or more examples, the measure of roundness can be characterized by a measure of curvature. In various examples, the measure of curvature can correspond to a radius of curvature of an osculating circle at a given region or segment of the boundary. In one or more illustrative examples, the measure of curvature can correspond to an inverse of the radius of curvature of an osculating circle at a given point of the boundary. In one or more additional examples, the measure of curvature can be characterized by arc length for a portion of a boundary. In at least some examples, the boundaries of the shapes can have at least a threshold measure of roundness. For example, sharp edges or intersecting segments of the boundaries can be absent from the shapes of structures of the initial metasurface design 108 and/or shapes of structures of the final metasurface design, such that the boundaries of the shapes have an amount of smoothness. In one or more further examples, structures included in at least one of the initial metasurface design 108 or the final metasurface design 110 can have multiple regions with different shapes. To illustrate, at least one of the initial metasurface design 108 or the final metasurface design 110 can include one or more first structures having a first shape, such as a circular shape or spherical shape, and one or more second structures having a second shape, such as an elliptical shape.

The dimensions included in at least one of the first structure characteristics 112 or the final structure characteristics 114 can correspond length, width, height, diameter, radius, circumference, perimeter, one or more combinations thereof and the like. In one or more examples, different portions of the structures included in the initial metasurface design 108 and/or the final metasurface design 110 can have different dimensions. For example, one or more structures included in the initial metasurface design 108 and/or the final metasurface design 110 can include a first region having first dimensions and a second region having second dimensions. To illustrate, one or more structures included in the initial metasurface design 108 and/or the final metasurface design 110 can a first region having a first diameter and a second region having a second diameter that is different from the first diameter. In one or more additional examples, one or more structures included in at least one of the initial metasurface design 108 or the final metasurface design 110 can have a first region having a first measure of roundness and a second region having a second measure of roundness. In these scenarios, one or more structures included in at least one of the initial metasurface design 108 or the final metasurface design 110 can have one or more regions with a greater measure of roundness than other regions. In still other examples, different individual structures included in the initial metasurface design 108 and/or the final metasurface design 110 can have different dimensions. To illustrate, a first structure included in the initial metasurface design 108 or the final metasurface design 110 can have one or more first dimensions and a second structure included in the initial metasurface design 108 or the final metasurface design 110 can have one or more second dimensions that are different from at least one of the one or more first dimensions.

The dimensions included in the first structure characteristics 112 and the final structure characteristics 114 can be on the order of a multiple of wavelengths of the electromagnetic radiation field incident on the metasurface. In one or more examples, dimensions included in the first structure characteristics 112 and the final structure characteristics 114 can be at least 0.005 times the wavelength of the electromagnetic radiation field incident on the metasurface, 0.01 times the wavelengths of the electromagnetic radiation field incident on the metasurface, at least 0.1 times the wavelengths of the electromagnetic radiation field incident on the metasurface, at least 1.0 times the wavelengths of the electromagnetic radiation field incident on the metasurface, at least 1.5 times the wavelengths of the electromagnetic radiation field incident on the metasurface, at least 2.0 times the wavelengths of the electromagnetic radiation field incident on the metasurface, at least 2.5 times the wavelengths of the electromagnetic radiation field incident on the metasurface, at least 2.8 times the wavelengths of the electromagnetic radiation field incident on the metasurface, at least 3 times the wavelengths of the electromagnetic radiation field incident on the metasurface, at least 3.5 times the wavelengths of the electromagnetic radiation field incident on the metasurface, at least 4 times the wavelengths of the electromagnetic radiation field incident on the metasurface, at least 4.5 times the wavelengths of the electromagnetic radiation field incident on the metasurface, at least 5 times the wavelengths of the electromagnetic radiation field incident on the metasurface, at least 6 times the wavelengths of the electromagnetic radiation field incident on the metasurface, at least 7 times the wavelengths of the electromagnetic radiation field incident on the metasurface, at least 8 times the wavelengths of the electromagnetic radiation field incident on the metasurface, at least 9 times the wavelengths of the electromagnetic radiation field incident on the metasurface, or at least 10 times the wavelengths of the electromagnetic radiation field incident on the metasurface. In one or more illustrative examples, dimensions of structures included in the initial metasurface design 108, and structures included in the final metasurface design 110 can be from 0.05 times to 2 times the wavelengths of the electromagnetic radiation field incident on the metasurface, from 0.1 times to 1.5 times the wavelengths of the electromagnetic radiation field incident on the metasurface, from 0. times to 10 times the wavelengths of the electromagnetic radiation field incident on the metasurface, from 5 times to 15 times the wavelengths of the electromagnetic radiation field incident on the metasurface, or from 3 times to 8 times the wavelengths of the electromagnetic radiation field incident on the metasurface.

In one or more additional examples, the dimensions included in the first structure characteristics 112 and the final structure characteristics 114 can be less than the wavelengths of the electromagnetic radiation field incident on the metasurface. For example, dimensions included in the first structure characteristics 112 and the final structure characteristics 114 can be no greater than 0.9 times the wavelengths of the electromagnetic radiation field incident on the metasurface, no greater than 0.8 times the wavelengths of the electromagnetic radiation field incident on the metasurface, no greater than 0.7 times the wavelengths of the electromagnetic radiation field incident on the metasurface, no greater than 0.6 times the wavelengths of the electromagnetic radiation field incident on the metasurface, no greater than 0.5 times the wavelengths of the electromagnetic radiation field incident on the metasurface, no greater than 0.4 times the wavelengths of the electromagnetic radiation field incident on the metasurface, no greater than 0.3 times the wavelengths of the electromagnetic radiation field incident on the metasurface, no greater than 0.2 times the wavelengths of the electromagnetic radiation field incident on the metasurface, no greater than 0.1 times the wavelengths of the electromagnetic radiation field incident on the metasurface, no greater than 0.05 times the wavelengths of the electromagnetic radiation field incident on the metasurface, or no greater than 0.01 times the wavelengths of the electromagnetic radiation field incident on the metasurface. In one or more illustrative examples, dimensions of structures included in the initial metasurface design 108 and structures included in the final metasurface design 110 can be from 0.01 times to 0.9 times the wavelengths of the electromagnetic radiation field incident on the metasurface, from 0.05 times to 0.5 times the wavelengths of the electromagnetic radiation field incident on the metasurface, from 0.1 times to 0.9 times the wavelengths of the electromagnetic radiation field incident on the metasurface, from 0.01 times to 0.1 times the wavelengths of the electromagnetic radiation field incident on the metasurface, or from 0.1 times to 0.5 times the wavelengths of the electromagnetic radiation field incident on the metasurface.

In one or more further examples, the dimensions included in the first structure characteristics 112 and the final structure characteristics 114 can be no greater than 500 μm, no greater than 300 μm, no greater than 200 μm, no greater than 100 μm, no greater than 80 μm, no greater than 50 μm, no greater than 20 μm, no greater than 10 μm, no greater than 1 μm, or no greater than 500 nanometers (nm). In various examples, the dimensions included in the first structure characteristics and the final structure characteristics can be at least 0.5 nm, at least 1 nm, at least 2 nm, at least 5 nm, at least 10 nm, at least 25 nm, at least 50 nm, at least 75 nm, at least 100 nm, at least 150 nm, at least 200 nm, at least 250 nm, or at least 300 nm. In one or more illustrative examples, the dimensions of structures of the initial metasurface design 108 and the final metasurface design 110 can be from about 0.5 nm to about 500 μm, from about 0.5 nm to about 100 nm, from about 100 nm to about 1 μm, from about 1 μm to about 100 μm, from about 50 μm to about 250 μm, from about 100 μm to about 500 μm, from about 1 μm to about 500 μm, or from about 10 nm to about 100 nm.

The first structure characteristics 112 and the final structure characteristics 114 can also include physical properties of structures included in at least one of the initial metasurface design 108 or the final metasurface design 110, mechanical properties of structures included in at least one of the initial metasurface design 108 or the final metasurface design 110, chemical properties of structures included in at least one of the initial metasurface design 108 or the final metasurface design 110, or one or more combinations thereof. For example, at least one of the first structure characteristics 112 or the final structure characteristics 114 can indicate dielectric permittivity of materials from which structures included in the initial metasurface design 108 and/or the final metasurface design 110 are formed.

In one or more examples, at least a portion of the final structure characteristics 114 can be different from the first structure characteristics 112. For example, during the metasurface design optimization process 102, at least a portion of the first structure characteristics 112 can be modified in relation to one or more iterations of the metasurface design optimization process 102 to produce the final structure characteristics 114. In one or more illustrative examples, the metasurface design optimization process 102 can modify shapes of structures of the initial metasurface design 108 to produce the final metasurface design. In various examples, the metasurface design optimization process 102 can cause boundaries or contours of the structures of the initial metasurface design 108 to be more complex to produce the final metasurface design 110. In at least some examples, the metasurface design optimization process 102 can modify boundaries of the structures included in the initial metasurface design 108 while maintaining an amount of roundness to the boundaries of the structures included in the final metasurface design 110. In one or more additional examples, the metasurface design optimization process 102 can modify at least one of locations of one or more structures included in the initial metasurface design 108 to produce the final metasurface design 110. In one or more further examples, the metasurface design optimization process 102 can modify dimensions of one or more structures included in the initial metasurface design 108 to produce the final metasurface design 110. In still other examples, additional characteristics of one or more structures included in the initial metasurface design 108 can be modified to generate the final metasurface design 110, such as one or more physical properties of one or more structures of the initial metasurface design 108, one or more chemical properties of one or more structures of the initial metasurface design 108, one or more mechanical properties of one or more structures of the initial metasurface design 108, one or more materials of one or more structures of the initial metasurface design 108, or one or more combinations thereof. In one or more additional illustrative examples, the metasurface design optimization process 102 can modify dielectric permittivities of one or more structures included in the initial metasurface design 108 to generate the final metasurface design 110. Dielectric permittivities of one or more structures included in the initial metasurface design 108 can be modified by changing at least one of dimensions or materials of one or more structures included in the initial metasurface design 108 to generate the final metasurface design 110.

In various examples, the initial metasurface design 108 can be generated from one or more predetermined libraries of metasurface structures. The one or more predetermined libraries can include structures having the same or approximately the same shape and the same dimensions or approximately the same dimensions. The one or more predetermined libraries can also include structures arranged in a periodic array. In one or more examples, the one or more predetermined libraries of metasurface structures can be generated under one or more sets of conditions and to achieve one or more functionalities. In at least some examples, one or more predetermined libraries can be identified to generate the initial metasurface design 108 based on one or more functionalities of the one or more predetermined libraries corresponding to one or more functionalities of the final metasurface design 110. In one or more additional examples, the one or more predetermined libraires can be identified to generate the initial metasurface design 108 based on one or more conditions under which the one or more predetermined libraries were generated corresponding to at least a portion of the one or more conditions for which the final metasurface design 110 is to be implemented. Further, one or more predetermined libraries of metasurface structures that correspond to the initial metasurface design 108 can have at least a minimum efficiency in relation to a target electromagnetic radiation field in response to an incident electromagnetic radiation field. The one or more predetermined libraries of metasurface structures used to generate the initial metasurface design 108 can be generated by at least one of the computing system 104 or an additional computing system that is separate from the computing system 104. In one or more examples, one or more predetermined libraries used to generate the initial metasurface design 108 can be imported from an additional computing system by the computing system 104 to generate the initial metasurface design 108.

The metasurface design optimization process 102 can include performing a number of iterations of a number of operations to modify the initial metasurface design 108 to generate the final metasurface design 110. The metasurface design optimization process 102 can include, at operation 116, simulating propagation of one or more electromagnetic radiation fields through a metasurface design. For the first iteration of the metasurface design optimization process 102, the simulation of the propagation of one or more electromagnetic radiation fields is performed with respect to the initial metasurface design 108. In one or more examples, propagation of a forward electromagnetic radiation field can be simulated through a metasurface design at operation 116. A forward electromagnetic radiation field can comprise an electromagnetic radiation field that is propagated upon an incident surface of a metasurface and exits through an output surface of the metasurface. The simulation corresponding to the forward electromagnetic radiation field can be performed using an electromagnetic radiation field that is expected to be applied to the metasurface being designed. For example, the simulation using the forward electromagnetic radiation field can be performed using an electromagnetic radiation field having wavelengths of an electromagnetic radiation field that is expected to be incident upon a metasurface designed using the metasurface design optimization process 102. The forward electromagnetic radiation field can contact the incident surface at an angle that corresponds to the angle at which the expected electromagnetic radiation field is to contact the metasurface being designed.

In one or more additional examples, a simulation propagating an adjoint electromagnetic radiation field through a metasurface design can be performed at operation 116. The adjoint electromagnetic radiation field can be propagated backwards through the metasurface being designed such that the adjoint electromagnetic radiation field enters the metasurface at the output surface and exits from the incident surface. The adjoint electromagnetic radiation field can correspond to a target electromagnetic radiation field that is to be produced after the metasurface has been designed. In various examples, the adjoint electromagnetic radiation field can correspond to the functionality to be provided by the metasurface being designed. In at least some examples, the adjoint electromagnetic radiation field can contact the output surface of the metasurface at angles at which the target electromagnetic radiation field is expected to exit the metasurface. Additionally, the adjoint electromagnetic radiation field can have at least one of a wavelength, a polarization state, or a distribution of electromagnetic radiation in one or more diffraction orders that corresponds to the target electromagnetic radiation field. In one or more illustrative examples, operation 116 can include performing a first simulation using a forward electromagnetic radiation field and a second simulation using an adjoint electromagnetic radiation field.

At operation 118, the metasurface design optimization process 102 can include determining an efficiency of a metasurface design with respect to the one or more simulations performed at operation 116. The efficiency of a metasurface design can correspond to a measure of similarity between the electromagnetic radiation fields produced in response to at least one of the forward electromagnetic radiation field or the adjoint electromagnetic radiation field and one or more target electromagnetic radiation fields. In at least some examples, the efficiency can indicate a level of correspondence between a measure of functionality provided by the current metasurface design in relation to a target measure of functionality. In one or more examples, the efficiency can be expressed in relation to a figure of merit. In various examples, the figure of merit can correspond to a target dielectric permittivity profile. In these scenarios, the efficiency of the metasurface design can be determined by analyzing a dielectric permittivity profile generated in response to at least one of the forward electromagnetic radiation field or the adjoint electromagnetic radiation field in relation to the dielectric permittivity profile of the figure of merit.

In one or more examples, at operation 120, the metasurface design optimization process 102 can determine whether the efficiency of the current metasurface design has been maximized or corresponds to a target efficiency. That is, the efficiency generated at operation 118 can be evaluated with respect to one or more efficiency criteria. In various examples, the metasurface design optimization process 102 can determine that the efficiency of the metasurface design has been maximized when the efficiency is at least a threshold efficiency. In one or more illustrative examples, the threshold efficiency can be at least about 75% of a target efficiency, at least about 80% of a target efficiency, at least about 85% of a target efficiency, at least about 90% of a target efficiency, at least about 95% of a target efficiency, at least about 97% of a target efficiency, at least about 99% of a target efficiency, at least about 99.5% of a target efficiency, or at least about 99.9% of a target efficiency. In one or more additional examples, the efficiency of a current metasurface design can be maximized in response to determining that a function used to determine the efficiency has converged to a local maximum.

In situations where the efficiency has been maximized and/or corresponds to a threshold target efficiency, the current metasurface design being analyzed by the metasurface design optimization process 102 is identified as the final metasurface design. In instances where the efficiency has not been maximized or does not correspond to a threshold target efficiency, the metasurface design optimization process 102 moves to operation 122. At operation 122, one or more characteristics of the current metasurface design are modified to generate a modified metasurface design 124. The modified metasurface design 124 is then analyzed with regard to the simulations propagating one or more electromagnetic radiation fields through the modified metasurface design 124 at operation 116 and the metasurface design optimization process 102 repeats until the efficiency is maximized and/or corresponds to a threshold target efficiency.

In various examples, the characteristics of a metasurface design modified by operation 122 can include shapes of one or more structures of the current metasurface design, dimensions of one or more structures of the current metasurface design, boundaries of one or more structures of the current metasurface design, materials of one or more structures of the current metasurface design, locations of one or more structures of the current metasurface design, physical properties of one or more structures of the current metasurface design, chemical properties of one or more structures of the current metasurface design, mechanical properties of one or more structures of the current metasurface design, one or more combinations thereof, and so forth. In at least some examples, modifying one or more characteristics of a current metasurface design can result in modification of one or more additional characteristics of the current metasurface design. For example, modifying at least one of boundaries, contours, or shape of one or more structures of the current metasurface design can cause a change in a dielectric permittivity profile of the current metasurface design.

In one or more illustrative examples, boundaries of individual structures of the metasurface design can be modified at operation 122. Modification of boundaries of individual structures of the metasurface design can change the shape of the individual structures. In various examples, an analysis of the simulations performed using the forward electromagnetic radiation field and the adjoint electromagnetic radiation field can be used to determine changes to boundaries of one or more structures of a current metasurface design. In at least some examples, the metasurface design optimization process 102 can be implemented at operation 122 such that changes to boundaries of structures of a metasurface design result in an increase in efficiency from the current metasurface design to the modified metasurface design 124. In one or more examples, constraints can be placed on changes to the characteristics of structures of the metasurface at operation 122. For example, constraints can be placed on modifications to boundaries of structures of a current metasurface design at operation 122 by causing boundaries of individual structures of the current metasurface design to maintain at least a threshold amount of roundness.

In one or more examples, the metasurface design optimization process 102 can include a number of iterations where changes are made to characteristics of the structures of a metasurface at each iteration. The efficiency of the metasurface can increase or at least stay the same from a first iteration to a second iteration of the metasurface design optimization process 102 based on the changes to the characteristics of the structures of the metasurface. For example, changes can be made to characteristics of the structures of a metasurface in a current iteration of the metasurface design optimization process 102 that increase the efficiency of the metasurface with respect to one or more previous iterations of the metasurface design optimization process 102.

After the metasurface design optimization process 102 has determined the final metasurface design 110, a metasurface can be manufactured according to the final metasurface design 110. In one or more examples, a metasurface corresponding to the final metasurface design 110 can be produced using an additive process that adds material of structures of the final metasurface design 110 to a substrate according to an arrangement that corresponds to the final metasurface design 110. In one or more additional examples, a metasurface corresponding to the final metasurface design 110 can be produced using a subtractive process where one or more layers of material of structures of the metasurface design are deposited onto a substrate and portions of the material are removed according to an arrangement that corresponds to the final metasurface design 110. In various examples, multiple layers of the final metasurface design 110 can be incorporated into a device. In still other examples, one or more layers that correspond to the final metasurface design 110 can be combined with one or more additional layers that correspond to a different metasurface design to produce a device including one or more metasurfaces.

A metasurface that corresponds to the final metasurface design 110 can be manufactured using one or more lithography processes, such as optical lithography, electron beam lithography, direct write lithography, nanoprint lithography, one or more combinations thereof, and the like. In one or more additional examples, one or more deposition processes can be implemented to produce a metasurface that corresponds to the final metasurface design 110. To illustrate, a metasurface can be manufactured according to the final metasurface design using atmospheric pressure chemical vapor deposition (CVD), low-pressure CVD, ultrahigh vacuum CVD, aerosol assisted CVD, direct liquid injection CVD, microwave plasma-assisted CVD, plasma-enhanced CVD, remote plasma-enhanced CVD, atomic layer CVD (also known as ALD), combustion CVD, hot filament CVD, hybrid physical-chemical vapor deposition, metalorganic CVD, rapid thermal CVD, photo-initiated CVD, sputtering, electron beam evaporation, thermal evaporation, wet chemical processing, ion bean deposition, one or more combinations thereof, and so forth. In one or more further examples, one or more etching processes, such as one or more chemical etching processes, one or more wet etching processes, and/or one or more dry etching processes can be implemented to manufacture a metasurface according to the final metasurface design 110. In still other examples, one or more polishing operations, such as one or more chemical-mechanical polishing (CIP) operations can be performed to manufacture a metasurface according to the final metasurface design 110.

In various examples, metasurfaces manufactured according to the final metasurface design 110 can also include additional components that can implement functionality of the metasurfaces. For example, metasurfaces manufactured according to the final metasurface design can include circuitry, connectors, or other devices to supply current or generate a voltage for at least a portion of the structures included in the metasurfaces. To illustrate, in one or more examples, metasurfaces designed according to the final metasurface design 110 can provide functionality when an amount of power is applied to features of the metasurfaces and the metasurfaces can include the electrical infrastructure to supply current or generate a voltage with respect to at least a portion of the structures of the metasurfaces.

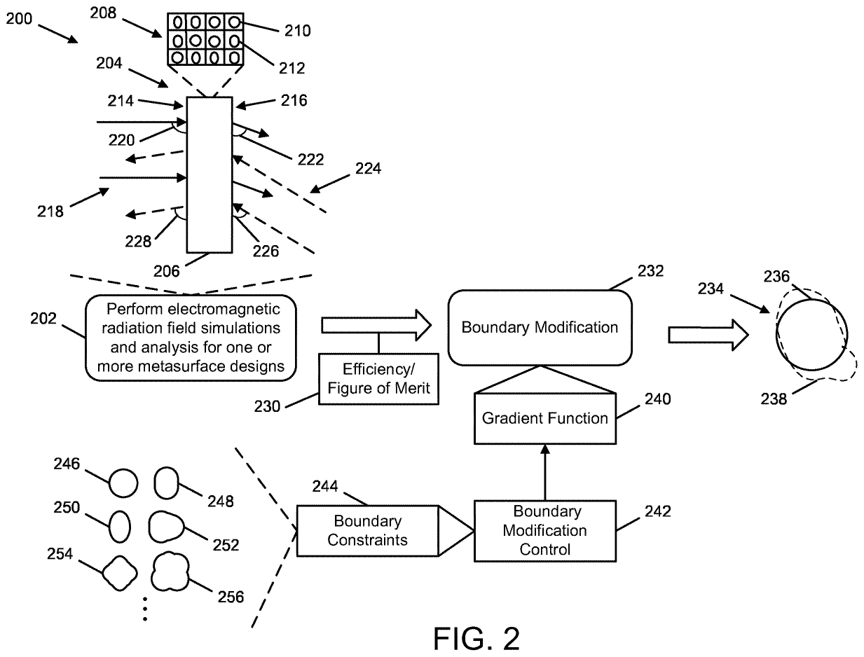

FIG. 2 illustrates a framework 200 to modify boundaries of structures of a metasurface design, in accordance with one or more example implementations. The framework 200 can include, at operation 202, performing a number of electromagnetic radiation field simulations for one or more metasurface designs and analyzing the response of the one or more metasurface designs to the number of electromagnetic radiation field simulations. The one or more metasurface designs can be implemented as a device 204. In one or more examples, the device 204 can correspond to one or more functionalities of the one or more metasurface designs. For example, the device 204 can include at least one of a metalense, a waveguide, a beam deflector, a beam splitter, a filter, a birefringence device, an effective medium theory device, a wireless communication device, an imaging device, or a multiplexing device.

In one or more examples, dimensions of the device 204 can be based on one or more functionalities of the device 204. In various examples, the device 204 can have dimensions from about 0.1 cm to about 10 m, from about 1 cm to about 5 m, from about 1 cm to about 30 cm, from about 20 cm to about 80 cm, from about 50 cm to about 5 m, from about 50 cm to about 2 m, from about 1 m to about 5 m, or from about 2 m to about 8 m. In at least some examples, a width or depth of the device 204 can be less than a height or length of the device 204. For example, the height or length of the device 204 can be at least 1.5 times the width or depth of the device 204, at least 2 times the width or depth of the device 204, at least 3 times the width or depth of the device 204, at least 5 times the width or depth of the device 204, at least 8 times the width or depth of the device 204, at least 10 times the width or depth of the device 204, at least 12 times the width or depth of the device 204, at least 15 times the width or depth of the device 204, at least 20 times the width or depth of the device 204, at least 40 times the width or depth of the device 204, at least 60 times the width or depth of the device 204, at least 80 times the width or depth of the device 204, or at least 100 times the width or depth of the device 204. In one or more illustrative examples, the device 204 can have a width or depth from about 0.5 cm to about 1 m and a length or height from about 10 cm to about 10 m. In various examples, the device 204 can comprise a roll of material having a length of 10 m, 20 m, 50 m, or more.

The device 204 can include one or more substrates, such as example substrate 206. An arrangement 208 can be formed on the substrate 206 according to a metasurface design. The arrangement 208 can include a number of structures, such as a first structure 210 and a second structure 212. In at least some examples, the structures of the arrangement 208 can be located in respective unit cells. In the illustrative example of FIG. 2, the first structure 210 can be located at a first location of the substrate 206 and the second structure 212 can be located at a second location of the substrate 206. In one or more examples, the first structure 210 and the second structure 212 can be separated by a distance. Although the illustrative example of FIG. 2 shows the arrangement 208 having three rows, four columns, and twelve structures, in one or more additional implementations, the arrangement 208 can have a different number of rows, a different number of columns, and a different number of structures than the illustrative example of FIG. 2. Further, the structures included in the arrangement 208 can be arranged in a periodic array or an aperiodic array. In various examples, the arrangement 208 can be formed on one or more layers of the substrate 206. In one or more additional examples, the arrangement 208 can be repeated on a number of layers of the substrate 206. In still other examples, the substrate 206 can include multiple layers and different arrangements of structures can be located on different layers of the substrate 206. In at least some instances, different arrangements of structures formed on different layers of the substrate 206 can correspond to different optical functionalities. In one or more illustrative examples, the arrangement 208 can correspond to one or more metasurface designs generated and analyzed in relation to the metasurface design optimization process 102 described with respect to FIG. 1. The substrate 206 also includes a first surface 214 and a second surface 216. In one or more scenarios, the arrangement 208 can be formed on at least one of the first surface 214 or the second surface 216.

The structures formed on the substrate 206 can have a number of characteristics. For example, the structures formed on the substrate 206 can have one or more dimensions. The structures formed on the substrate 206 can also have one or more physical properties, one or more mechanical properties, and/or one or more chemical properties. At least a portion of the characteristics of the structures formed on the substrate 206 can be based on one or more materials included in the structures. In one or more illustrative examples, the structures located on the substrate 206 can comprise at least one of silicon, carbon, oxygen, nitrogen, one or more alkali earth metals, one or more alkaline earth metals, one or more transition metals, or one or more halogens. In various examples, the structures formed on the substrate 206 can be comprised of at least one of one or more metallic materials, one or more semiconducting materials, or one or more dielectric materials. In one or more examples, the structures formed on the substrate 206 can be comprised of at least one of one or more polymeric materials, one or more glass materials, or one or more inorganic materials. In one or more additional illustrative examples, the structures formed on the substrate 206 can be comprised of at least one of crystalline silicon, polycrystalline silicon, amorphous silicon, silicon dioxide (SiO₂), aluminum oxide (Al₂O₃), silicon nitride (Si₃N₄) or titanium dioxide (TiO₂). Additionally, the substrate 206 can be formed from one or more glass materials.

In one or more examples, the substrate 206 can comprise at least 60% by weight of one or more glass materials, at least 65% by weight of one or more glass materials, at least 70% by weight of one or more glass materials, at least 75% by weight of one or more glass materials, at least 80% by weight of one or more glass materials, at least 85% by weight of one or more glass materials, at least 90% by weight of one or more glass materials, at least 95% by weight of one or more glass materials, or at least 99% by weight of one or more glass materials In various examples, the substrate 206 can comprise a glass material having an amount of silica and an amount of one or more additional components. As used herein, the term “silica” can refer to silicon dioxide (SiO₂). In one or more illustrative examples, the substrate 206 can comprise pure silica. In one or more additional illustrative examples, the substrate 206 can comprise fused silica. In one or more further illustrative examples, the substrate 206 can comprise one or more aluminum oxides. For example, the substrate 206 can comprise Al₂O₃. In still further illustrative examples, the substrate 206 can comprise boron trioxide (B₂O₃). In various illustrative examples, the substrate 206 can comprise one or more alkaline earth metals. To illustrate, the substrate 206 can comprise at least one of MgO, CaO, SrO, or BaO. In one or more implementations, the substrate 206 can comprise an alkaline earth boro-aluminosilicate glass. In at least some examples, a metasurface in addition to or separate from the substrate 206 can be comprised of the one or more glass materials.

In one or more implementations, the substrate 206 can comprise a glass material having silica content that is greater than content of any other component of the glass material. For example, the substrate 206 can comprise at least 50 mole % silica, at least 55 mole % silica, at least 60 mole % silica, at least 65 mole % silica, at least 70 mole % silica, at least 75 mole % silica, at least 80 mole % silica, at least 85 mole % silica by weight, at least 90 mole % silica, at least about 95 mole % silica, or at least about 99 mole % silica. In various examples, substantially all of the substrate 206 can be comprised of silica. In one or more illustrative examples, the substrate 206 can be comprised of pure silica. In one or more additional illustrative examples, the substrate 206 can be comprised of from about 50 mole % silica to about 99 mole % silica, from about 60 mole % to about 90 mole % silica, from about 75 mole % to about 95 mole % silica, from about 50 mole % silica to about 70 mole % silica, from about 60 mole % silica to about 80 mole % silica, or from about 80 mole % silica to about 95 mole % silica.

In scenarios where the substrate 206 comprises an aluminum oxide, the amount of aluminum oxide present in the substrate 206 can be from 5 mole % to 40 mole %, from 10 mole % to 30 mole %, from 20 mole % to 40 mole %, from 10 mole % to 20 mole %, from 20 mole % to 30 mole %, or from 25 mole % to 40 mole %. In implementations where the substrate 206 comprises boron trioxide, the amount of boron trioxide present in the substrate 206 can be from 5 mole % to 40 mole %, from 10 mole % to 30 mole %, from 20 mole % to 40 mole %, from 10 mole % to 20 mole %, from 20 mole % to 30 mole %, or from 25 mole % to 40 mole %. Additionally, in instances where the substrate 206 comprises one or more alkaline earth metals, the amount of an individual alkaline earth metal present in the substrate 206 can comprise from 0.05 mole % to 10 mole %, from 0.5 mole % to 10 mole %, from 2 mole % to 10 mole %, from 2 mole % to 5 mole %, from 6 mole % to 9 mole %, or from 0.05 mole % to 1 mole %. Mole % as used herein can refer to mole percent calculated on an oxide basis.

At operation 202, a simulation of a forward electromagnetic radiation field 218 can be applied to the substrate 206. For example, the simulation of the forward electromagnetic radiation field 218 can be incident upon the first surface 214 at a first angle of incidence 220 and exit the second surface 216 at a first output angle 222. Additionally, a simulation of an adjoint electromagnetic radiation field 224 can be incident upon the second surface 216 at a second angle of incidence 226 and exit the first surface 214 at a second output angle 228. In one or more illustrative examples, the simulation of the forward electromagnetic radiation field 218 can be performed by simulating the placement of a first number of current sources on the first surface 214 and projecting movement of current from the first number of current sources through the substrate 206 to the second surface 216. The first number of current sources can be configured according to one or more wavelengths and one or more intensities of electromagnetic radiation that is expected to be applied to the device 204 in relation to one or more functionalities of the device 204. In one or more additional illustrative examples, the simulation of the adjoint electromagnetic radiation field 224 can be performed by simulating the placement of a second number of current sources on the second surface 216 and projecting movement of current from the second number of current sources through the substrate 206 to the first surface 214. The second number of current sources can be configured according to one or more wavelengths and one or more intensities of a target electromagnetic radiation field to be produced by the device 204 in response to the expected applied electromagnetic radiation field to be incident upon the device 204.

The analysis performed at operation 202 with respect to the simulations of the forward electromagnetic radiation field 218 and the adjoint electromagnetic radiation field 224 can include determining an efficiency 230 of the arrangement 208. In various examples, the efficiency 230 of the arrangement 208 can be indicated by a figure of merit that corresponds to the arrangement 208. The figure of merit can indicate a measure of similarity between the output electromagnetic radiation field produced by the first electromagnetic radiation field 218 being incident upon the first surface 214 and a target electromagnetic radiation field. In one or more examples, the figure of merit can correspond to a dielectric permittivity profile produced by the arrangement 208 in response to the first electromagnetic radiation field 218 being applied to the device 204. In one or more illustrative examples, the efficiency can correspond to the absolute efficiency that indicates the fraction of incident power converted into the target electromagnetic radiation field. In one or more additional illustrative examples, a figure of merit (F) can be calculated according to:

$$F = \frac{1}{4 {P}_{t}} {\int }_{S} ( E \times {H}_{t}^{*} + {E}_{t}^{*} \times H ) \cdot n da ,$$

where E corresponds to the electric field component of the incident electromagnetic radiation field, such as the first electromagnetic radiation field 218, Eₜ* corresponds to the electric field component of the target electromagnetic radiation field, H corresponds to the magnetic field component of the incident electromagnetic radiation field, Hₜ* corresponds to the magnetic field component of the target electromagnetic radiation field, N is the normal to the output surface S, such as the second surface 216, and Pₜ corresponds to a power normalization factor. In at least some examples, the incoming and target electromagnetic radiation fields can be normalized using Pₜ=1 W and the efficiency (q) 230 can be expressed as η=|F|².

At operation 232, modifications to boundaries of one or more structures included in the arrangement 208 can be performed to increase the efficiency 230 of the device 204. For example, an individual structure 234 of the arrangement 208 can have first boundaries 236. In response to operation 232, the first boundaries can be modified to second boundaries 238. The changes to the boundaries of one or more structures of the arrangement 208 can be determined by predicting a change to the electromagnetic radiation field output by the device 204 that causes the electromagnetic radiation field output by the device 204 to have an increased efficiency 230. The change to the electromagnetic radiation field output by the device 204 can be based on the modified versions of the boundaries of structures of the arrangement 208 determined at operation 232. In one or more examples, the changes to the electromagnetic radiation field output by the device 204 in response to an input electromagnetic radiation field can be predicted by modifying a first number of current sources used to simulate the first electromagnetic radiation field 218 according to a second number of current sources used to simulate the second electromagnetic radiation field 224. In one or more illustrative examples, relationships and/or correlations can be determined between the first number of current sources and the second number of current sources based on the electromagnetic radiation fields generated in response to the first electromagnetic radiation field 218 and the second electromagnetic radiation field 224. Based on these relationships and/or correlations, a change can be predicted to the boundaries of one or more structures of the arrangement 208 that can cause changes to the first number of current sources that, in turn, results in an increase in the efficiency 230 of the device 204. By using the relationships and/or correlations between the first number of current sources and the second number of current sources to generate changes to the boundaries of structures of the arrangement 208, a trial-and-error approach or a brute force approach for determining the changes to the boundaries of the structures can be avoided resulting in the use of fewer computational resources to perform the boundary modifications of operation 232 than when a trial-and-error approach or a brute force approach is used.

In various examples, the modifications to the boundaries of one or more structures of the arrangement 208 can be indicated by changes to dielectric permittivity of the one or more structures. In one or more illustrative examples, the change in the efficiency (δη) can be expressed as:

$$δη = \frac{ωδϵ}{2 {P}_{t}} {\int }_{Γ} {u}_{⊥} g ds ,$$

where u_{⊥} is a deformation function defined along the cross-section boundary of an individual structure Γ, ω is the angular optical frequency, and δ∈=∈−∈′ is the difference in dielectric permittivity between the material comprising the structures of the arrangement 208 and the surrounding medium.

The boundaries of structures of the arrangement 208 can be modified according to a gradient function 240. The gradient function 240 (g), can be expressed as:

$$g = Re [ {jF}^{*} \int {E}_{\vert \vert} \cdot {E}_{a , \vert \vert} + \frac{1}{{ϵϵ}^{′}} {D}_{⊥} \cdot {D}_{a , ⊥} d z ] ,$$

where E_{∥} corresponds to the tangential electric field component of the forward electromagnetic radiation field, E_{a,∥} corresponds to the tangential electric field component of the adjoint electromagnetic radiation field, normal displacement D_{⊥} is the normal displacement electric field component of the forward electromagnetic radiation field, and D_{a,⊥} corresponds to the normal displacement electric field component of the adjoint electromagnetic radiation field. In one or more examples, the gradient function can be used to determine a magnitude and direction that individual points of the boundaries of the shapes of the arrangement 208 are to be modified to result in an increase in the efficiency 230.

Although in the illustrative example of the gradient function g above, the computations are performed in the z-direction, in other examples, changes can be made to one or more structures of a metasurface in the z-direction. For example, in the illustrative example of the gradient function g above, the structures in the z-direction can have a relatively constant shape, such as a linear shape. That is, the sidewalls of the structures can have a relatively constant shape. In at least some examples, Fourier coefficients that correspond to the shape of the structures in the z-direction can be designated to remain constant. In one or more additional examples, at least a portion of the constraints on the shape of the structures of the metasurface in the z-direction can be removed. To illustrate, one or more lower order Fourier coefficients, such as at least one of a zero-order Fourier coefficient, a first-order Fourier coefficient, a second-order Fourier coefficient, or a third-order Fourier coefficient, of structures in the z-direction can be modified to change a shape of the structures in the z-direction. In various example, the z-direction can indicate a direction that extends perpendicular to a surface of the substrate 206 and/or a layer disposed within the substrate 206. Additionally, although the sidewalls of the structures of the arrangement 208 can initially be disposed at an approximately 90° angle in the z-direction, in other examples, the sidewalls of the structures of the arrangement 208 can be slanted, such as at an angle from about 5° to about 60° in the z-direction. In these scenarios, the angle at which the sidewalls of the structures are disposed can also be modified as part of the metasurface design optimization process in addition to or in the alternative with respect to a shape of the sidewalls of the structures.

In one or more examples, boundary modification control 242 can be applied to the gradient function 240 to provide one or more constraints to the modifications of the boundaries of the structures of the arrangement 208 that take place with respect to operation 232. For example, the boundary modification control 242 can be applied to cause at least a threshold amount of roundness to be present with respect to the boundaries of individual structures included in the arrangement 208 after the boundary modification that takes place at operation 232. To illustrate, in at least some instances, the gradient function 240 without the boundary modification control 242 can determine that boundaries to one or more structures of the arrangement 208 can be modified to produce sharp edges, holes, or discontinuities in the boundaries of the one or more structures that can result in difficulty of manufacturing a metasurface that includes structures having these boundaries. The boundary modification control 242 can be applied to minimize or eliminate characteristics of structures that may result in manufacturing difficulties or lead to less efficient devices.

The boundary modification control 242 can be applied to the gradient function 240 using one or more boundary constraints 244. The one or more boundary constraints can correspond to one or more criteria directed to maintaining a threshold amount of roundness in the boundaries of structures of the arrangement 208. In one or more illustrative examples, the boundary modification control 242 can apply a Fourier decomposition to the gradient function 240 and the one or more boundary constraints 244 can correspond to orders or coefficients of the Fourier decomposition function terms applied to the gradient function 240. In one or more examples, the order of the Fourier decomposition function terms can correspond to shapes of the structures of the arrangement. For example, a zero order Fourier decomposition function term can correspond to a first shape 246, a first order Fourier decomposition function term can correspond to a second shape 248, a second order Fourier decomposition function term can correspond to a third shape 250, a third order Fourier decomposition function term can correspond to a fourth shape 252, a fourth order Fourier decomposition function term can correspond to can correspond to a fifth shape 254, and a fifth order Fourier decomposition function term can correspond to a sixth shape 256. In various examples, a portion of the Fourier decomposition function terms that correspond to the shapes 246, 248, 250, 252, 254, 256 can be applied to the gradient function 240. To illustrate, a zero order Fourier decomposition function term can be applied to the gradient function 240 to generate boundaries of structures of the arrangement 208 that have a shape that corresponds to the shape 246. Additionally, a zero order Fourier decomposition function term and a first order Fourier decomposition function term can be applied to the gradient function 240 to generate boundaries of structures of the arrangement 208 that have a shape that corresponds to at least one of the first shape 246 or the second shape 248. In various examples, the boundary constraints 244 can correspond to a greater number of shapes and corresponding Fourier decomposition function terms than the six shapes shown in the illustrative example of FIG. 2. In addition, individual Fourier coefficients can independently modify an efficiency of a metasurface design. To illustrate, a zero-order Fourier decomposition term can independently modify the efficiency of a metasurface design in relation to a first-order or another higher order Fourier decomposition term, a first order Fourier decomposition term can modify independently modify the efficiency of a metasurface design in relation to a zero-order and/or a higher order Fourier decomposition term, and so forth. Thus, the efficiency of a metasurface design can increase in situations where a subset of Fourier decomposition terms are modified.

In one or more illustrative examples, a Fourier decomposition function can be applied to the gradient function 240 by expressing the boundary deformation function u_{⊥} as:

$${u}_{⊥} = h sign ( δϵ ) ( \frac{{a}_{0}}{2} + {\sum }_{m = 1}^{∞} {a}_{m} cos m θ + {b}_{m} sin m θ ) ,$$

where (aₘ, bₘ) are the expansion coefficients, m indicates the order of the expansion coefficients, and θ indicates the angle of deflection. The change in efficiency can then be expressed as:

$$δ η = \frac{ωδϵ}{4 {P}_{t}} h {s}_{t} sign ( δϵ ) [ \frac{{a}_{0}^{2}}{2} + {\sum }_{m = 1}^{∞} ( {a}_{m}^{2} + {b}_{m}^{2} ) ] .$$

In one or more examples, the operations 202 and 232 can be repeated a number of times until the efficiency 230 corresponds to a threshold efficiency or until a value of the efficiency 230 converges to a local optimum. The local optimum can correspond to a local maximum or a local minimum depending on the metasurface design optimization process being used. Additionally, although the illustrative example of applying a Fourier decomposition function to the gradient function 240 has been described, in other examples, additional functions can be applied to the gradient function 240 to constrain changes to boundaries of the structures of the arrangement 208. To illustrate, a Chebyshev function can be applied to the gradient function to modify shapes of the structures of a metasurface design.

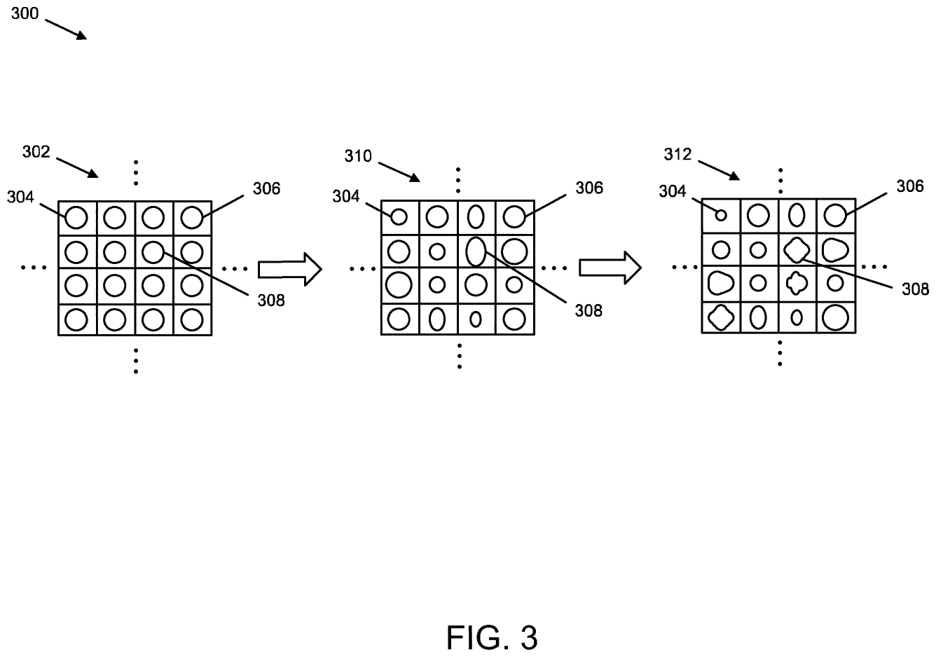

FIG. 3 illustrates a sequence 300 showing modifications to boundaries of structures included in a design of a metasurface, in accordance with one or more example implementations. The sequence 300 includes a first arrangement 302 that includes a first number of structures of a metasurface design. For example, the first arrangement 302 can include a first structure 304, a second structure 306, and a third structure 308. The structures of the first arrangement 302 can have one or more characteristics, such as a shape, one or more dimensions, one or more materials, one or more combinations thereof, and so forth. At least a portion of the one or more characteristics of at least a portion of the structures of the metasurface design can be changed as the sequence 300 progresses. In one or more illustrative examples, the sequence 300 can indicate changes to a metasurface design during a number of iterations of the metasurface design optimization process described in relation to FIG. 1.

The sequence 300 can also include a second arrangement 310 that is subsequent to the first arrangement 302. In one or more examples, the second arrangement 310 can be determined directly after the first arrangement 302. In one or more additional examples, one or more intervening arrangements can be generated between the first arrangement 302 and the second arrangement 310. The second arrangement 310 can indicate changes to characteristics of a number of individual structures. In various examples, the second arrangement 310 can indicate changes to the respective shapes and/or dimensions of individual structures. To illustrate, the second arrangement 310 indicates that a diameter of the first structure 304 has decreased with respect to the diameter of the first structure 304 in the first arrangement 302. Additionally, the second arrangement 310 indicates that a shape of the third structure 308 has changed from a circle or cylinder in the first arrangement 302 to an oval in the second arrangement 310. The second arrangement 310 can also indicate that characteristics of other structures can remain the same as the characteristics of structures in the first arrangement 302. For example, the dimensions and shape of the second structure 306 are the same in the first arrangement 302 and the second arrangement 310.

Further, the sequence 300 can include a third arrangement 312 that is subsequent to the second arrangement 310. In one or more examples, the third arrangement 312 can be determined directly after the second arrangement 310. In one or more additional examples, one or more intervening arrangements can be generated between the second arrangement 310 and the third arrangement 312. The third arrangement 312 can indicate changes to characteristics of a number of individual structures. For example, the third arrangement 312 can indicate changes to the respective shapes and/or dimensions of individual structures. In one or more illustrative examples, the third arrangement 312 indicates that the diameter of the first structure 304 has decreased from the diameter of the first structure 304 in the second arrangement 310. Additionally, the third arrangement 312 indicates that the shape of the third structure 308 has become more complex than the shape of the third structure in the second arrangement 310. In at least some examples, changes to the shapes of the structures included in the arrangements of the sequence 300 can be constrained based on the order of terms of a Fourier decomposition function applied to a gradient function that is used to determine changes to boundaries of structures in the arrangements of the sequence 300. The third arrangement 312 can also indicate that characteristics of other structures can remain the same as the characteristics of structures in the second arrangement 310. In the illustrative example of FIG. 3, the dimensions and shape of the second structure 306 are the same in the second arrangement 310 and the third arrangement 312.

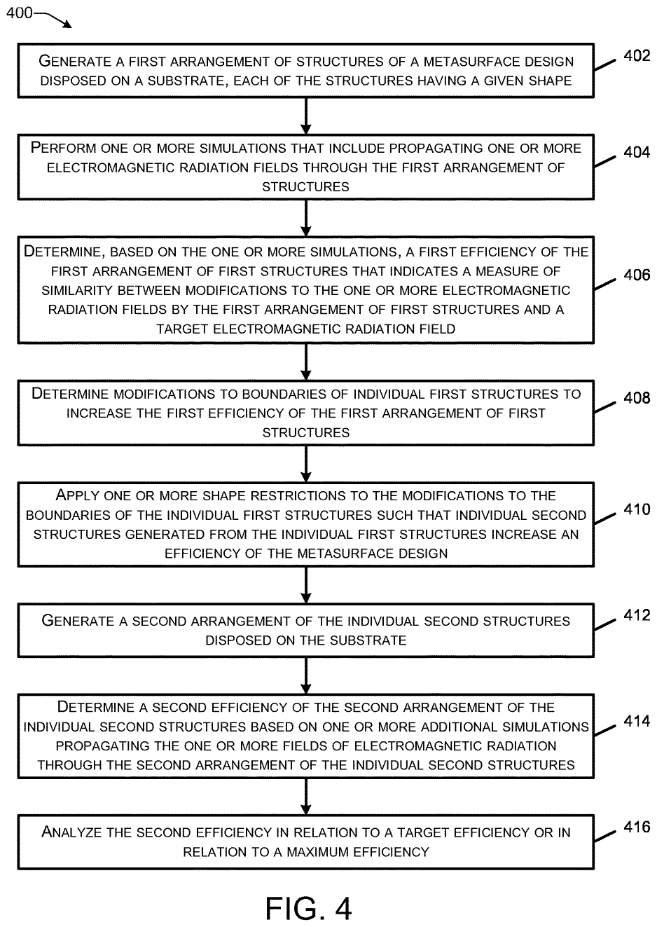

FIG. 4 illustrates a flowchart of an example process 400 to produce a device that directs the path of electromagnetic radiation, in accordance with one or more implementations. The processes may be embodied in computer-readable instructions for execution by one or more processors such that the operations of the processes may be performed in part or in whole by the functional components of the computing system 104. Accordingly, the processes described below are by way of example with reference thereto, in some situations. However, in other implementations, at least some of the operations of the processes described with respect to FIG. 4 may be deployed on various other hardware configurations. The processes described with respect to FIG. 4 are therefore not intended to be limited to the computing system 104 and can be implemented in whole, or in part, by one or more additional components. Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

At operation 402, the process 400 can include generating a first arrangement of first structures of a metasurface design disposed on a substrate. Individual first structures can have a given shape. In one or more examples, the first arrangement of shapes can include an initial metasurface design. In various examples, the first arrangement of shapes can be generate using a predefined library of geometrical shapes and based on transmission responses and phase responses of individual first structures in relation to a predefined set of parameters of the geometrical shapes. In at least some examples, dimensions of the first structures can correspond to wavelengths of electromagnetic radiation incident upon the substrate.

In addition, the process 400 can include, at operation 404, performing one or more simulations that include propagating one or more electromagnetic radiation fields through the first arrangement of structures. The one or more simulations can include a forward electromagnetic radiation field simulation. The forward electromagnetic radiation field simulation can include a first simulation to propagate a first field of electromagnetic radiation through the first arrangement of first structures along a first path having a first direction and that is incident on a first surface of the substrate and exits a second surface of the substrate. In at least some examples, the second surface can be substantially parallel to the first surface. The one or more simulations can also include an adjoint electromagnetic radiation field simulation. The adjoint electromagnetic radiation field simulation can include a second simulation to propagate a second electromagnetic radiation field through the first arrangement of first structures along a second path having a second direction and that is incident on the second surface of the substrate and exits the first surface of the substrate.

In at least some examples, the one or more simulations can be based on functionality of a metasurface that includes an arrangement of structures. In situations where the metasurface is to be configured to modify the path of a plurality of wavelengths of electromagnetic radiation, first simulations can be performed to propagate first electromagnetic radiation fields through the first arrangement of the first structures, where the first electromagnetic radiation fields have a first range of frequencies of electromagnetic radiation. Additionally, second simulations can be performed to propagate second electromagnetic radiation fields through the first arrangement of the first structures, where the second electromagnetic radiation fields have a second range of frequencies of electromagnetic radiation that are at least partially different from the first range of frequencies of electromagnetic radiation. Further, when the metasurface is to be configured to change polarization states of incident electromagnetic radiation, first simulations can be performed to propagate first electromagnetic radiation fields through the first arrangement of the first structures, where the first electromagnetic radiation fields include electromagnetic radiation having a first polarization state. In addition, second simulations can be performed to propagate second electromagnetic radiation fields through the first arrangement of the first structures, where the second electromagnetic radiation fields include electromagnetic radiation having a second polarization state that is different from the first polarization state.

The process 400 can also include, at operation 406, determining, based on the one or more simulations, a first efficiency of the first arrangement of first structures. The first efficiency can indicate a measure of similarity between modifications to the one or more electromagnetic radiation fields by the first arrangement of first structures and a target electromagnetic radiation field. In various examples, the efficiency can correspond to a figure of merit. In one or more illustrative examples, the efficiency can be determined based on a dielectric permittivity profile generated by the first arrangement of first structures in response to the one or more simulations and in relation to a target dielectric permittivity profile.

Further, at operation 408, the process 400 can include determining, based on the first efficiency, modifications to boundaries of individual first structures to increase the first efficiency of the first arrangement of first structures. In one or more examples, determining the modifications to the boundaries of the individual first structures include implementing a gradient function to determine a magnitude and direction of modification of individual points along the boundaries of the first structures. In at least some examples, the gradient function can include a number of coefficients with individual coefficients of the number of coefficients corresponding to a different amount of modification of the boundaries of the first structures. In one or more illustrative examples, a subset of the number of coefficients can be determined and used to implement the gradient function.

At operation 410, the process 400 can include applying one or more boundary constraints to the modifications to the boundaries of the individual first structures such that individual second structures generated from the individual first structures increase an efficiency of the metasurface design. For example, the metasurface design can be generated according to an optimization process that includes a number of iterations and with each iteration of the optimization process, changes to the boundaries of the metasurface structures are made in a subsequent iteration that result in a value of the efficiency of the metasurface design that is at least the value of the efficiency in one or more previous iterations of the optimization process. In various examples, the efficiency of the metasurface design increases between at least a portion of the iterations of the optimization process. In at least some illustrative examples, the boundaries of the structures can be changed such that the individual first structures include segments having at least a threshold amount of roundness. In one or more examples, the one or more boundary constraints can be applied to the modifications to the boundaries of the individual first structures by implementing a Fourier decomposition technique.

Additionally, the process 400 can include, at operation 412, generating a second arrangement of the individual second structures disposed on the substrate. In one or more examples, a first portion of the second structures can have a first shape and a second portion of the second structures can have a second shape that is different from the first shape. In one or more illustrative examples, the first structures can include first cylinders having a substantially same diameter and the second structures include second cylinders having boundaries that have an amount of deformation relative to boundaries of the first cylinders. In one or more additional examples, a first portion of the second structures can have a first shape and a second portion of the second structures can have a second shape that is different from the first shape with one or more first dimensions of the first shape being different from one or more second dimensions of the second shape. In one or more further examples, shapes of the first structures and/or shapes of the second structures can have a rectangular shape or a shape with one or more straight edges. In one or more additional illustrative examples, at least one of one or more first structures or one or more second structures can include boundaries having a mixture of rounded segments and linear segments.

The process 400 can include, at operation 414, determining a second efficiency of the second arrangement of the individual second structures based on one or more additional simulations propagating the one or more fields of electromagnetic radiation through the second arrangement of the individual second structures. In at least some examples, the first efficiency and the second efficiency can be determined based on a difference between a first dielectric permittivity of one or more materials comprising the first structures and the second structures and a second dielectric permittivity of a medium in which the first structures and the second structures are located

At operation 416, the process 400 can include analyzing the second efficiency in relation to a target efficiency or in relation to a maximum efficiency. In situations where the second efficiency does not correspond to the target efficiency or does not represent a local maximum efficiency, the process 400 can be repeated.

In various examples, a metasurface designed according to at least a portion of the operations 402, 404, 406, 408, 410, 412, 414, 416 can include a substrate having an arrangement of structures disposed on the substrate. The substrate can be comprised of one or more glass materials. Additionally, the structures can be comprised of one or more materials. For example, the structures can be comprised of one or more silicon-containing materials. the structures can also be comprised of Silicon, Silicon Nitride, TiO₂, chalcogenide glasses, fused silica, HfO₂, and so forth.

The arrangement can be designed to have at least a threshold efficiency or a maximum efficiency in relation to one or more functionalities. In one or more examples, the structures can have dimensions that correspond to wavelengths of electromagnetic radiation incident upon the substrate. In one or more additional examples, the structures of the arrangement can include first structures having a first shape. The first shape can have one or more first segments with each first segment of the one or more first segments having at least a threshold amount of roundness. The structures of the arrangement can also include second structures having a second shape different from the first shape. In one or more further examples, the second shape can have one or more second segments with each second segment of the one or more second segments having at least the threshold amount of roundness. Additionally, one or more first dimensions of the first shape can be different from one or more second dimensions of the second shape.

In one or more additional examples, the individual structures of the arrangement of structures can be disposed in individual unit cells. The unit cells can be coupled to circuitry and the circuitry can provides current to the individual unit cells to cause electromagnetic radiation passing through the arrangement of structures to be modified. In one or more illustrative examples, the device can be configured as a beam deflector, a metalense, or a waveguide.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

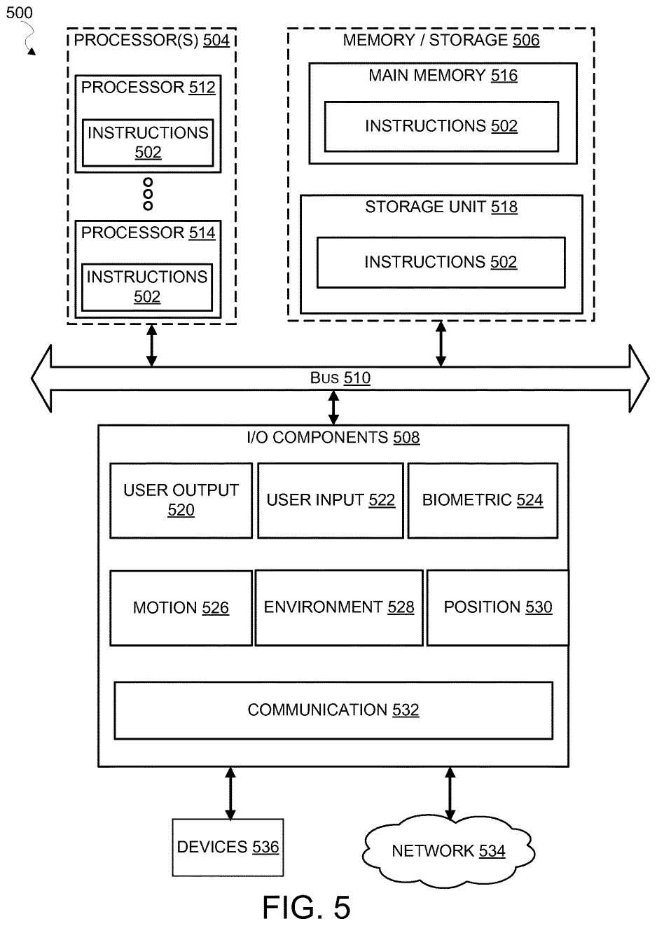

FIG. 5 is a block diagram illustrating components of a machine 500, according to some example implementations, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 502 (e.g., software, a program, an application, an applet, an app, or other executable code) for causing the machine 500 to perform any one or more of the methodologies discussed herein may be executed. As such, the instructions 502 may be used to implement modules or components described herein. The instructions 502 transform the general, non-programmed machine 500 into a particular machine 500 programmed to carry out the described and illustrated functions in the manner described. In alternative implementations, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, at network switch, a network bridge, or any machine capable of executing the instructions 502, sequentially or otherwise, that specify actions to be taken by machine 500. Further, while only a single machine 500 is illustrated, the term “machine” shall also be taken to include a collection of machines that individually or jointly execute the instructions 502 to perform any one or more of the methodologies discussed herein.

The machine 500 may include processors 504, memory/storage 506, and I/O components 508, which may be configured to communicate with each other such as via a bus 510. “Processor” in this context, refers to any circuit or virtual circuit (a physical circuit emulated by logic executing on an actual processor 504) that manipulates data values according to control signals (e.g., “commands,” “op codes,” “machine code,” etc.) and which produces corresponding output signals that are applied to operate a machine 500. In an example implementation, the processors 504 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 502. The term “processor” is intended to include multi-core processors 504 that may comprise two or more independent processors (sometimes referred to as “cores”) that may execute instructions 502 contemporaneously. Although FIG. 5 shows multiple processors 504, the machine 500 may include a single processor 512 with a single core, a single processor 512 with multiple cores (e.g., a multi-core processor), multiple processors 512, 514 with a single core, multiple processors 512, 514 with multiple cores, or any combination thereof.

The memory/storage 506 may include memory, such as a main memory 516, or other memory storage, and a storage unit 518, both accessible to the processors 504 such as via the bus 510. The storage unit 518 and main memory 516 store the instructions 502 embodying any one or more of the methodologies or functions described herein. The instructions 502 may also reside, completely or partially, within the main memory 516, within the storage unit 518, within at least one of the processors 504 (e.g., within the processor's cache memory), or any suitable combination thereof, during execution thereof by the machine 500. Accordingly, the main memory 516, the storage unit 518, and the memory of processors 504 are examples of machine-readable media. “Machine-readable media,” also referred to herein as “computer-readable storage media”, in this context, refers to a component, device, or other tangible media able to store instructions 502 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” may be taken to include a single medium or multiple media (e.g., a centralized or distributed database, or associated caches and servers) able to store instructions 502. The term “machine-readable medium” shall also be taken to include any medium, or combination of multiple media, that is capable of storing instructions 502 (e.g., code) for execution by a machine 500, such that the instructions 502, when executed by one or more processors 504 of the machine 500, cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 508 may include a wide variety of components to receive input, provide output, produce output, transmit information, exchange information, capture measurements, and so on. The specific I/O components 508 that are included in a particular machine 500 will depend on the type of machine. For example, portable machines such as mobile phones will likely include a touch input device or other such input mechanisms, while a headless server machine will likely not include such a touch input device. It will be appreciated that the I/O components 508 may include many other components that are not shown in FIG. 5. The I/O components 508 are grouped according to functionality merely for simplifying the following discussion and the grouping is in no way limiting. In various example implementations, the I/O components 508 may include user output components 520 and user input components 522. The user output components 520 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 522 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example implementations, the I/O components 508 may include biometric components 524, motion components 526, environmental components 528, or position components 530 among a wide array of other components. For example, the biometric components 524 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 526 may include acceleration sensor components (e.g., accelerometer), gravitation sensor components, rotation sensor components (e.g., gyroscope), and so forth. The environmental components 528 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 530 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 may include communication components 532 operable to couple the machine 500 to a network 534 or devices 536. For example, the communication components 532 may include a network interface component or other suitable device to interface with the network 534. In further examples, communication components 532 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 536 may be another machine 500 or any of a wide variety of peripheral devices (e.g., a peripheral device coupled via a USB).

Moreover, the communication components 532 may detect identifiers or include components operable to detect identifiers. For example, the communication components 532 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 532, such as location via Internet Protocol (IP) geo-location, location via Wi-Fi® signal triangulation, location via detecting an NFC beacon signal that may indicate a particular location, and so forth.

“Component,” in this context, refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an ASIC. A hardware component may also include programmable logic or circuitry that is temporarily configured by software to perform certain operations. For example, a hardware component may include software executed by a general-purpose processor 504 or other programmable processor. Once configured by such software, hardware components become specific machines (or specific components of a machine 500) uniquely tailored to perform the configured functions and are no longer general-purpose processors 504. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering implementations in which hardware components are temporarily configured (e.g., programmed), each of the hardware components need not be configured or instantiated at any one instance in time. For example, where a hardware component comprises a general-purpose processor 504 processor 504 configured by software to become a special-purpose processor, the general-purpose processor 504 processor 504 may be configured as respectively different special-purpose processors (e.g., comprising different hardware components) at different times. Software accordingly configures a particular processor 512, 514 or processors 504, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In implementations in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices, and can operate on a resource (e.g., a collection of information). The various operations of example methods described herein may be performed, at least partially, by one or more processors 504 that are temporarily configured (e.g., by software) or permanently configured to perform the relevant operations. Whether temporarily or permanently configured, such processors 504 may constitute processor-implemented components that operate to perform one or more operations or functions described herein. As used herein, “processor-implemented component” refers to a hardware component implemented using one or more processors 504. Similarly, the methods described herein may be at least partially processor-implemented, with a particular processor 512, 514 or processors 504 being an example of hardware. For example, at least some of the operations of a method may be performed by one or more processors 504 or processor-implemented components. Moreover, the one or more processors 504 may also operate to support performance of the relevant operations in a “cloud computing” environment or as a “software as a service” (SaaS). For example, at least some of the operations may be performed by a group of computers (as examples of machines 500 including processors 504), with these operations being accessible via a network 534 (e.g., the Internet) and via one or more appropriate interfaces (e.g., an API). The performance of certain of the operations may be distributed among the processors, not only residing within a single machine 500, but deployed across a number of machines. In some example implementations, the processors 504 or processor-implemented components may be located in a single geographic location (e.g., within a home environment, an office environment, or a server farm). In other example implementations, the processors 504 or processor-implemented components may be distributed across a number of geographic locations.

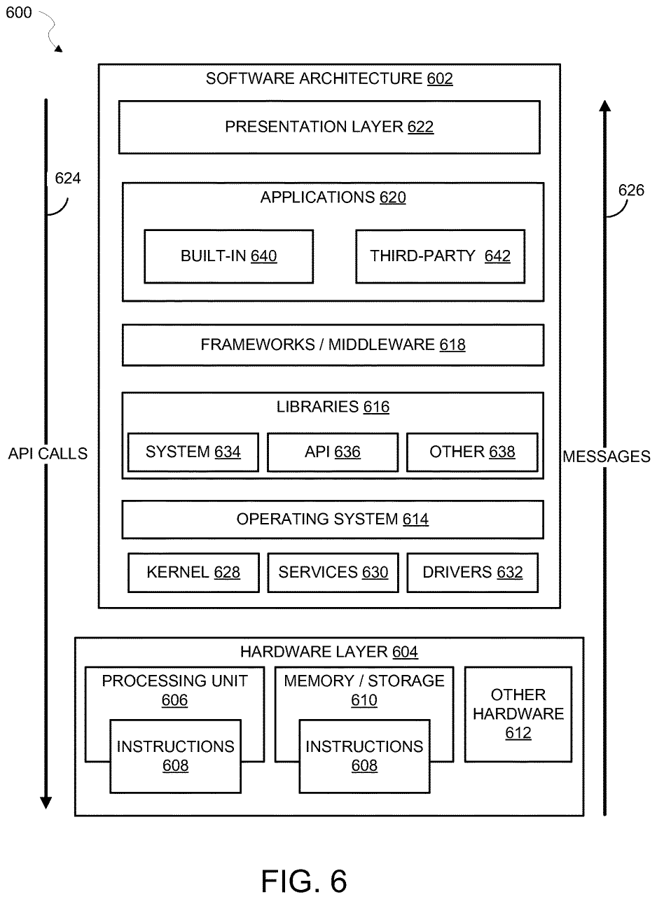

FIG. 6 is a block diagram illustrating system 600 that includes an example software architecture 602, which may be used in conjunction with various hardware architectures herein described. FIG. 6 is a non-limiting example of a software architecture, and it will be appreciated that many other architectures may be implemented to facilitate the functionality described herein. The software architecture 602 may execute on hardware such as machine 500 of FIG. 5 that includes, among other things, processors 504, memory/storage 506, and input/output (I/O) components 508. A representative hardware layer 604 is illustrated and can represent, for example, the machine 500 of FIG. 5. The representative hardware layer 604 includes a processing unit 606 having associated executable instructions 608. Executable instructions 608 represent the executable instructions of the software architecture 602, including implementation of the methods, components, and so forth described herein. The hardware layer 604 also includes at least one of memory or storage modules memory/storage 610, which also have executable instructions 608. The hardware layer 604 may also comprise other hardware 612.

In the example architecture of FIG. 6, the software architecture 602 may be conceptualized as a stack of layers where each layer provides particular functionality. For example, the software architecture 602 may include layers such as an operating system 614, libraries 616, frameworks/middleware 618, applications 620, and a presentation layer 622. Operationally, the applications 620 or other components within the layers may invoke API calls 624 through the software stack and receive messages 626 in response to the API calls 624. The layers illustrated are representative in nature and not all software architectures have all layers. For example, some mobile or special purpose operating systems may not provide a frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 are responsible for controlling or interfacing with the underlying hardware. For instance, the drivers 632 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 provide a common infrastructure that is used by at least one of the applications 620, other components, or layers. The libraries 616 provide functionality that allows other software components to perform tasks in an easier fashion than to interface directly with the underlying operating system 614 functionality (e.g., kernel 628, services 630, drivers 632). The libraries 616 may include system libraries 634 (e.g., C standard library) that may provide functions such as memory allocation functions, string manipulation functions, mathematical functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware 618 (also sometimes referred to as middleware) provide a higher-level common infrastructure that may be used by the applications 620 or other software components/modules. For example, the frameworks/middleware 618 may provide various graphical user interface functions, high-level resource management, high-level location services, and so forth. The frameworks/middleware 618 may provide a broad spectrum of other APIs that may be utilized by the applications 620 or other software components/modules, some of which may be specific to a particular operating system 614 or platform.

The applications 620 include built-in applications 640 and third-party applications 642. Examples of representative built-in applications 640 may include, but are not limited to, a contacts application, a browser application, a book reader application, a location application, a media application, a messaging application, or a game application. Third-party applications 642 may include an application developed using the ANDROID™ or IOS™ software development kit (SDK) by an entity other than the vendor of the particular platform and may be mobile software running on a mobile operating system such as IOS™ ANDROID™, WINDOWS® Phone, or other mobile operating systems. The third-party applications 642 may invoke the API calls 624 provided by the mobile operating system (such as operating system 614) to facilitate functionality described herein.

The applications 620 may use built-in operating system functions (e.g., kernel 628, services 630, drivers 632), libraries 616, and frameworks/middleware 618 to create UIs to interact with users of the system. Alternatively, or additionally, in some systems, interactions with a user may occur through a presentation layer, such as presentation layer 622. In these systems, the application/component “logic” can be separated from the aspects of the application/component that interact with a user.

Changes and modifications may be made to the disclosed implementations without departing from the scope of the present disclosure. These and other changes or modifications are intended to be included within the scope of the present disclosure, as expressed in the following claims.

Some implementations are described as numbered aspects (Aspect 1, 2, 3, etc.). These are provided as examples only and do not limit the technology disclosed herein.

Aspect 1. A method comprising: generating, by a computing system comprising one or more processors and memory, a first arrangement of first structures of a metasurface design disposed on a substrate, each of the first structures having a given shape; performing, by the computing system, one or more simulations that include propagating one or more electromagnetic radiation fields through the first arrangement of structures; determining, by the computing system and based on the one or more simulations, a first efficiency of the first arrangement of first structures, wherein the first efficiency indicates a measure of similarity between modifications to the one or more electromagnetic radiation fields by the first arrangement of first structures and a target electromagnetic radiation field; determining, by the computing system and based on the first efficiency, modifications to boundaries of individual first structures to increase the first efficiency of the first arrangement of first structures; applying, by the computing system, one or more boundary constraints to the modifications to the boundaries of the individual first structures such that individual second structures generated from the individual first structures increase an efficiency of the metasurface design; generating, by the computing system, a second arrangement of the individual second structures disposed on the substrate; determining, by the computing system, a second efficiency of the second arrangement of the individual second structures based on one or more additional simulations propagating the one or more fields of electromagnetic radiation through the second arrangement of the individual second structures; and analyzing, by the computing system, the second efficiency in relation to a target efficiency or in relation to a maximum efficiency.

Aspect 2. The method of aspect 1, wherein the one or more simulations include: performing, by the computing system, a first simulation to propagate a first field of electromagnetic radiation through the first arrangement of first structures along a first path having a first direction and that is incident on a first surface of the substrate and exits a second surface of the substrate that is substantially parallel to the first surface; and performing, by the computing system, a second simulation to propagate a second electromagnetic radiation field through the first arrangement of first structures along a second path having a second direction and that is incident on the second surface of the substrate and exits the first surface of the substrate.

Aspect 3. The method of aspect 1, wherein performing the one or more simulations includes: performing, by the computing system, first simulations to propagate first electromagnetic radiation fields through the first arrangement of the first structures, the first electromagnetic radiation fields having a first range of frequencies of electromagnetic radiation; and performing, by the computing system, second simulations to propagate second electromagnetic radiation fields through the first arrangement of the first structures, the second electromagnetic radiation fields having a second range of frequencies of electromagnetic radiation that are at least partially different from the first range of frequencies of electromagnetic radiation.

Aspect 4. The method of aspect 1, wherein performing the one or more simulations includes: performing, by the computing system, first simulations to propagate first electromagnetic radiation fields through the first arrangement of the first structures, the first electromagnetic radiation fields including electromagnetic radiation having a first polarization state; and performing, by the computing system, second simulations to propagate second electromagnetic radiation fields through the first arrangement of the first structures, the second electromagnetic radiation fields including electromagnetic radiation having a second polarization state that is different from the first polarization state.

Aspect 5. The method of any one of aspects 1-4, comprising: generating, by the computing system, the first arrangement of the first structures using a predefined library of geometrical shapes and based on transmission responses and phase responses of individual first structures in relation to a predefined set of parameters of the geometrical shapes.

Aspect 6. The method of any one of aspects 1-5, wherein the one or more boundary constraints are applied to the modifications to the boundaries of the individual first structures by implementing a Fourier decomposition technique.

Aspect 7. The method of any one of aspects 1-6, wherein determining the modifications to the boundaries of the individual first structures includes implementing a gradient function to determine a magnitude and direction of modification of individual points along the boundaries of the first structures.

Aspect 8. The method of aspect 7, wherein the gradient function includes a number of coefficients with individual coefficients of the number of coefficients corresponding to a different amount of modification of the boundaries of the first structures.

Aspect 9. The method of aspect 8, comprising determining, by the computing system, a subset of the number of coefficients to determine in relation to implementing the gradient function.

Aspect 10. The method of any one of aspects 1-9, wherein a first portion of the second structures have a first shape and a second portion of the second structures have a second shape that is different from the first shape.

Aspect 11. The method of any one of aspects 1-10, wherein the first efficiency and the second efficiency are determined based on a difference between a first dielectric permittivity of one or more materials comprising the first structures and the second structures and a second dielectric permittivity of a medium in which the first structures and the second structures are located.

Aspect 12. The method of any one of aspects 1-11, wherein a first portion of the second structures have a first shape and a second portion of the second structures have a second shape that is different from the first shape.

Aspect 13. The method of aspect 12, wherein the first structures include first cylinders having a substantially same diameter and the second structures include second cylinders having boundaries that have an amount of deformation relative to boundaries of the first cylinders.

Aspect 14. The method of aspect 12, wherein one or more first dimensions of the first shape are different from one or more second dimensions of the second shape.

Aspect 15. The method of any one of aspects 1-14, wherein dimensions of the first structures correspond to wavelengths of electromagnetic radiation incident upon the substrate.

Aspect 16. A system comprising: one or more hardware processors; and memory storing computer-readable instructions that, when executed by the one or more hardware processors, cause the one or more processors to perform operations comprising: generating a first arrangement of first structures of a metasurface design disposed on a substrate, each of the first structures having a given shape; performing one or more simulations that include propagating one or more electromagnetic radiation fields through the first arrangement of structures; determining, based on the one or more simulations, a first efficiency of the first arrangement of first structures, wherein the first efficiency indicates a measure of similarity between modifications to the one or more electromagnetic radiation fields by the first arrangement of first structures and a target electromagnetic radiation field; determining, based on the first efficiency, modifications to boundaries of individual first structures to increase the first efficiency of the first arrangement of first structures; applying one or more boundary constraints to the modifications to the boundaries of the individual first structures such that individual second structures generated from the individual first structures include segments increase an efficiency of the metasurface design; generating a second arrangement of the individual second structures disposed on the substrate; determining a second efficiency of the second arrangement of the individual second structures based on one or more additional simulations propagating the one or more fields of electromagnetic radiation through the second arrangement of the individual second structures; and analyzing the second efficiency in relation to a target efficiency or in relation to a maximum efficiency.

Aspect 17. The system of aspect 16, wherein the one or more simulations include: performing a first simulation to propagate a first field of electromagnetic radiation through the first arrangement of first structures along a first path having a first direction and that is incident on a first surface of the substrate and exits a second surface of the substrate that is substantially parallel to the first surface; and performing a second simulation to propagate a second electromagnetic radiation field through the first arrangement of first structures along a second path having a second direction and that is incident on the second surface of the substrate and exits the first surface of the substrate.

Aspect 18. The system of aspect 16, wherein performing the one or more simulations includes: performing first simulations to propagate first electromagnetic radiation fields through the first arrangement of the first structures, the first electromagnetic radiation fields having a first range of frequencies of electromagnetic radiation; and performing second simulations to propagate second electromagnetic radiation fields through the first arrangement of the first structures, the second electromagnetic radiation fields having a second range of frequencies of electromagnetic radiation that are at least partially different from the first range of frequencies of electromagnetic radiation.

Aspect 19. The system of aspect 16, wherein performing the one or more simulations includes: performing first simulations to propagate first electromagnetic radiation fields through the first arrangement of the first structures, the first electromagnetic radiation fields including electromagnetic radiation having a first polarization state; and performing second simulations to propagate second electromagnetic radiation fields through the first arrangement of the first structures, the second electromagnetic radiation fields including electromagnetic radiation having a second polarization state that is different from the first polarization state.

Aspect 20. The system of any one of aspects 16-19, wherein the memory stores additional computer-readable instructions that, when executed by the one or more hardware processors, cause the one or more hardware processors to perform additional operations comprising: generating the first arrangement of the first structures using a predefined library of geometrical shapes and based on transmission responses and phase responses of individual first structures in relation to a predefined set of parameters of the geometrical shapes.

Aspect 21. The system of any one of aspects 16-20, wherein the one or more boundary constraints are applied to the modifications to the boundaries of the individual first structures by implementing a Fourier decomposition technique.

Aspect 22. The system of any one of aspects 16-21, wherein determining the modifications to the boundaries of the individual first structures includes implementing a gradient function to determine a magnitude and direction of modification of individual points along the boundaries of the first structures.

Aspect 23. The system of aspect 22, wherein the gradient function includes a number of coefficients with individual coefficients of the number of coefficients corresponding to a different amount of modification of the boundaries of the first structures.

Aspect 24. The system of aspect 23, wherein the memory stores additional computer-readable instructions that, when executed by the one or more hardware processors, cause the one or more hardware processors to perform additional operations comprising: determining a subset of the number of coefficients to determine in relation to implementing the gradient function.

Aspect 25. The system of any one of aspects 16-24, wherein a first portion of the second structures have a first shape and a second portion of the second structures have a second shape that is different from the first shape.

Aspect 26. The system of any one of aspects 16-25, wherein the first efficiency and the second efficiency are determined based on a difference between a first dielectric permittivity of one or more materials comprising the first structures and the second structures and a second dielectric permittivity of a medium in which the first structures and the second structures are located.

Aspect 27. The system of any one of aspects 16-26, wherein a first portion of the second structures have a first shape and a second portion of the second structures have a second shape that is different from the first shape.

Aspect 28. The system of aspect 27, wherein the first structures include first cylinders having a substantially same diameter and the second structures include second cylinders having boundaries that have an amount of deformation relative to boundaries of the first cylinders.

Aspect 29. The system of aspect 27, wherein one or more first dimensions of the first shape are different from one or more second dimensions of the second shape.

Aspect 30. The system of any one of aspects 16-29, wherein dimensions of the first structures correspond to wavelengths of electromagnetic radiation incident upon the substrate.

Aspect 31. A device comprising: a substrate; and an arrangement of structures disposed on the substrate, the structures having dimensions that correspond to wavelengths of electromagnetic radiation incident upon the substrate and the structures including: first structures having a first shape, the first shape having one or more first segments with each first segment of the one or more first segments having at least a threshold amount of roundness; and second structures having a second shape different from the first shape, the second shape having one or more second segments with each second segment of the one or more second segments having at least the threshold amount of roundness.

Aspect 32. The device of aspect 31, wherein one or more first dimensions of the first shape are different from one or more second dimensions of the second shape.

Aspect 33. The device of aspect 31 or 32, wherein individual structures of the arrangement of structures are disposed in individual unit cells, wherein the unit cells are coupled to circuitry and the circuitry provides current to the individual unit cells to cause electromagnetic radiation passing through the arrangement of structures to be modified.

Aspect 34. The device of any one of aspects 31-33, wherein the substrate is comprised of one or more glass materials.

Aspect 35. The device of any one of aspects 31-34, wherein the structures are comprised of one or more silicon-containing materials.

Aspect 36. The device of any one of aspects 31-25, wherein the device is configured as a beam deflector, a metalense, or a waveguide.

### EXAMPLES

### Example 1

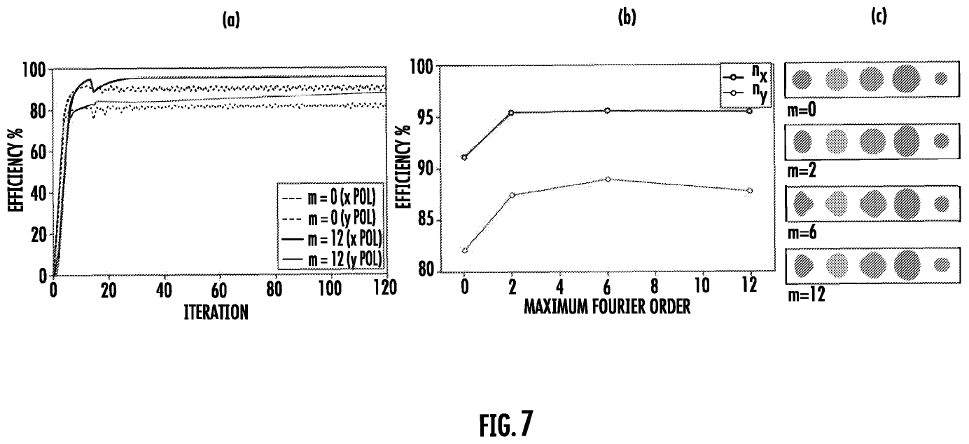

Maintaining simple circular shapes. In the first example, a 40-degrees beam deflector is designed by considering different Fourier orders in our basis decomposition. The design domain is initialized with five identical circular pillars (200 nm diameter) spaced by 500 nm, and then the shape optimization is performed multiple times, each one restricting to a different the number of Fourier terms. As one can see in FIG. 7, item (a), the efficiency is initially 0 as a uniform array spaced by less than half lambda does not deflect an incoming beam and is then taken to above 80% for the optimized structures even if only circular shapes only are allowed (i.e., zeroth order only). This optimization considered both orthogonal polarization states. The final efficiency is plotted in FIG. 7, item (b) as a function of the maximum Fourier order retained. The gain in efficiency by allowing higher orders is only about 5% and, depending on the application, that may or may not be relevant. This example illustrates the effectiveness of this approach in controlling the complexity of the final structure. Restricting the allowed orders reduces the design space, and it is not surprising that the efficiency may increase with higher Fourier orders. Even with higher orders, smoothness of the structure is ensured given the nature of Fourier basis (in other words, very high orders would be needed to lead to sharp peaks).

FIG. 7 describes optimization of a dual-polarization 40-degree beam deflector. Item (a) illustrates the absolute efficiency evolution at each iteration, where dashed curves represent restricting the gradient function to zeroth Fourier order (i.e., maintaining circular shape), while solid line allows up to 12^{th} order. In item (b), the final efficiency as a function of the maximum allowed Fourier order is plotted, and item (c) illustrates the corresponding final metasurface shape. For this simulation, we used amorphous silicon pillars with height of 950 nm on Eagle glass substrate. Optimization was performed at 1550 nm wavelength.

### Example 2

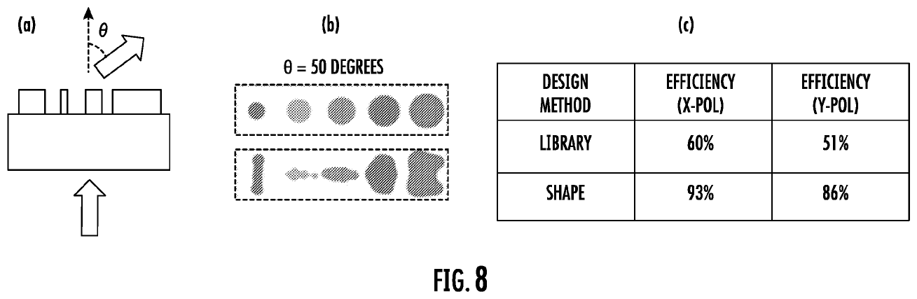

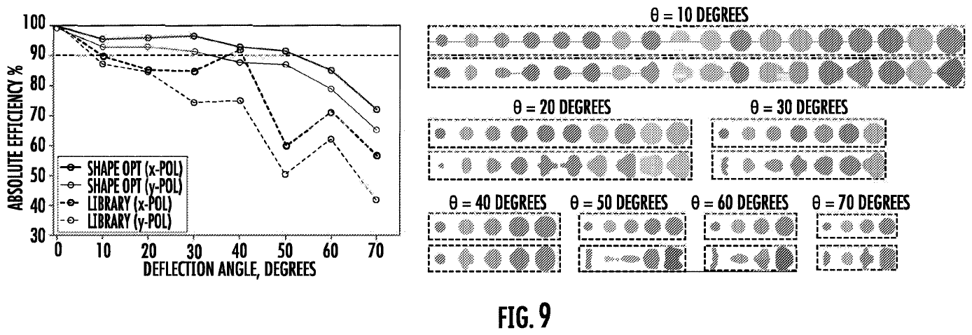

Initializing with library-based design. One of the advantages of the present method is that we can initialize the domain with a known structure that performs relatively well. This helps skip over low efficiency local optimums. For example, one might choose to initialize with a metasurface designed based on the library approach. In FIG. 8, a 50-degrees beam deflector is initially designed using a library of amorphous silicon circular pillars on glass. As one can see, the efficiency is relatively low at 60% and 51% for orthogonal polarization states. Moreover, even though the library itself is polarization independent (circular pillars on a square unit cell), the actual device does exhibit polarization dependence. This illustrates the impact of the interaction between different neighboring pillars, which is not taken into account in the library design. The final device performance cannot be precisely predicted from the performance of the individual unit cells. The shape optimization then takes this design and substantially increase the efficiency to 93% and 86% by properly considering their interaction. In FIG. 9, the same approach was utilized to design beam deflectors up to 70 degrees. Consistently, the shape optimization resulted in better performance than the initial library design, and all beam deflectors from 0 to 50 degrees have absolute efficiencies near 90% for both polarizations.

FIG. 8 illustrates shape optimization of a metasurface using the library design as initialization. Schematic of a beam deflector at an arbitrary angle θ is shown in item (a), where light and dark gray colors indicate respectively the substrate and the metasurfaces. The optimization was initialized with a beam deflector designed based on the library approach, shown in the top image in item (b), and the final structure is shown in the bottom image in item (b). A comparison of the efficiency before and after optimization is shown in item (c) for both polarizations. For this simulation, we used amorphous silicon pillars with height of 900 nm on a fused silica glass substrate. Optimization was performed at 1550 nm.

FIG. 9 illustrates shape optimization of a metasurface using the library design as initialization. Left graph shows the efficiency of the initial library design (dashed line) and the efficiency of the final shape optimized structure (solid line). All beam deflectors are optimized simultaneously for both input polarizations. For each deflection angle, the initial library design and the final optimized shapes are shown on the right of the plot. For this simulation, amorphous silicon pillars were used with height of 900 nm on a fused silica glass substrate. Optimization was performed at 1550 nm wavelength.

### Example 3

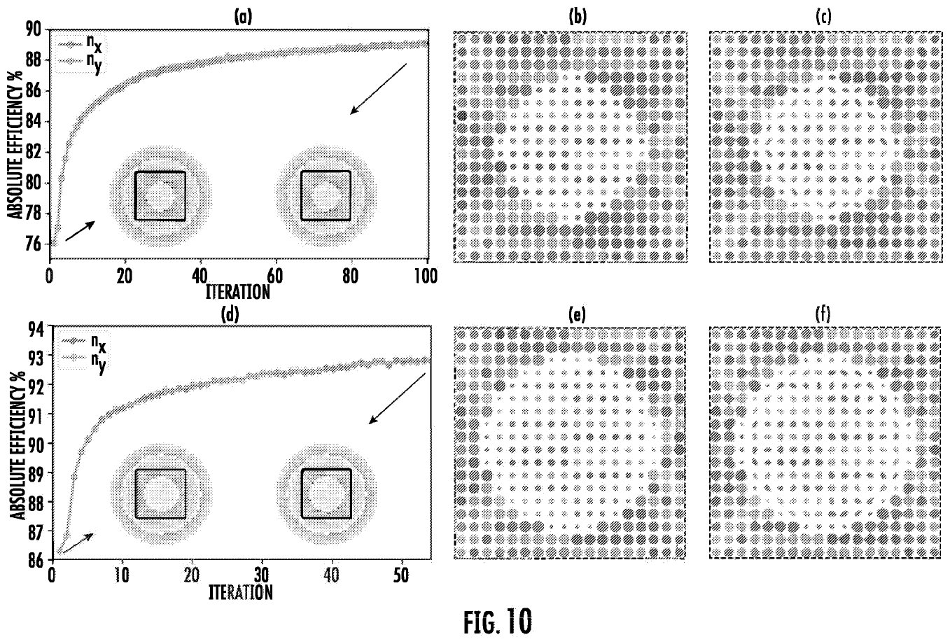

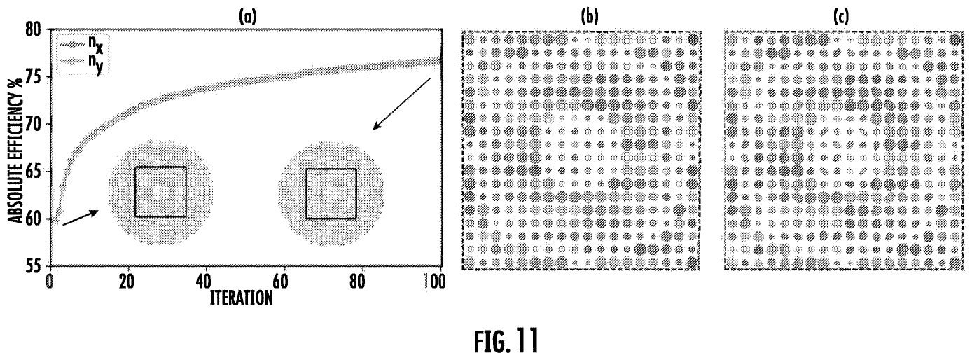

High efficiency, dual-polarization metalenses. Metalenses are one of the most popular devices based on metasurfaces. Yet, obtaining high efficiency is still a challenge. Here, shape optimization is applied to two metalenses (both with NA~0.32 at 1550 nm), each initially designed with slightly different libraries. The only difference between them is an arbitrary choice on a global phase which leads to different distribution of pillar diameters. Their initial efficiencies are different, one at 76% and the other at 86% (FIG. 10, item (a) and FIG. 10, item (d)). Again, libraries do not take the interaction between different pillars into account and variation in performance is then expected from one library to another. In FIG. 10, item (a), the first metalens has an absolute efficiency around 76% and is increased to 89% for both polarizations after optimization. The initial and final structures are shown in FIG. 10, item (b) and FIG. 10, item (c). The second metalens had the best possible performance we could find with such library, and still the shape optimization increased the efficiency from 86% to 93% for both polarization states (FIG. 10, item (d)). Again, this is a remarkable result considering that we refer to absolute efficiency based on actual field projection, and for both polarizations. The initial and final structures are shown in FIG. 10, item (e) and FIG. 10, item (f). In FIG. 11, a high efficiency, high NA, dual-polarization metalens is designed. Obtaining high efficiency for high NA becomes even more difficult. In this example, we took a metalens designed with the library approach with a numerical aperture of 0.7 and increased its efficiency from 59% to 77% after 100 iterations.

Although one or more implementations have been described with reference to specific example implementations, it will be evident that various modifications and changes may be made to these implementations without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific implementations in which the subject matter may be practiced. The implementations illustrated are described in sufficient detail to enable those skilled in the art to practice the teachings disclosed herein. Other implementations may be utilized and derived therefrom, such that structural and logical substitutions and changes may be made without departing from the scope of this disclosure. This Detailed Description, therefore, is not to be taken in a limiting sense, and the scope of various implementations is defined only by the appended claims, along with the full range of equivalents to which such claims are entitled.

Although specific implementations have been illustrated and described herein, it should be appreciated that any arrangement calculated to achieve the same purpose may be substituted for the specific implementations shown. This disclosure is intended to cover any and all adaptations or variations of various implementations. Combinations of the above implementations, and other implementations not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single implementation for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separate implementation.

1. A method comprising:
generating, by a computing system comprising one or more processors and memory, a first arrangement of first structures of a metasurface design disposed on a substrate, each of the first structures having a given shape;
performing, by the computing system, one or more simulations that include propagating one or more electromagnetic radiation fields through the first arrangement of first structures;
determining, by the computing system and based on the one or more simulations, a first efficiency of the first arrangement of first structures, wherein the first efficiency indicates a measure of similarity between modifications to the one or more electromagnetic radiation fields by the first arrangement of first structures and a target electromagnetic radiation field;
determining, by the computing system and based on the first efficiency, modifications to boundaries of individual first structures to generate second structures to increase the first efficiency of the first arrangement of first structures;
applying, by the computing system, one or more boundary constraints to the modifications to the boundaries of the individual first structures such that individual second structures generated from the individual first structures increase an efficiency of the metasurface design;
generating, by the computing system, a second arrangement of the individual second structures disposed on the substrate;
determining, by the computing system, a second efficiency of the second arrangement of the individual second structures based on one or more additional simulations propagating the one or more electromagnetic radiation fields through the second arrangement of the individual second structures; and
analyzing, by the computing system, the second efficiency in relation to a target efficiency or in relation to a maximum efficiency.

2. The method of claim 1, wherein the one or more simulations include:
performing, by the computing system, a first simulation to propagate a first field of electromagnetic radiation through the first arrangement of first structures along a first path having a first direction and that is incident on a first surface of the substrate and wherein the substrate includes a second surface of the substrate that is substantially parallel to the first surface; and
performing, by the computing system, a second simulation to propagate a second electromagnetic radiation field through the first arrangement of first structures along a second path having a second direction and that is incident on the second surface of the substrate.

3. The method of claim 1, wherein performing the one or more simulations includes:
performing, by the computing system, first simulations to propagate first electromagnetic radiation fields through the first arrangement of the first structures, the first electromagnetic radiation fields having a first range of frequencies of electromagnetic radiation; and
performing, by the computing system, second simulations to propagate second electromagnetic radiation fields through the first arrangement of the first structures, the second electromagnetic radiation fields having a second range of frequencies of electromagnetic radiation that are at least partially different from the first range of frequencies of electromagnetic radiation.

4. The method of claim 1, wherein performing the one or more simulations includes:
performing, by the computing system, first simulations to propagate first electromagnetic radiation fields through the first arrangement of the first structures, the first electromagnetic radiation fields including electromagnetic radiation having a first polarization state; and
performing, by the computing system, second simulations to propagate second electromagnetic radiation fields through the first arrangement of the first structures, the second electromagnetic radiation fields including electromagnetic radiation having a second polarization state that is different from the first polarization state.

5. The method of claim 1, comprising:
generating, by the computing system, the first arrangement of the first structures using a predefined library of geometrical shapes and based on transmission responses and phase responses of individual first structures in relation to a predefined set of parameters of the geometrical shapes.

6. The method of claim 1, wherein the one or more boundary constraints are applied to the modifications to the boundaries of the individual first structures by implementing a Fourier decomposition technique.

7. The method of claim 1, wherein determining the modifications to the boundaries of the individual first structures includes implementing a gradient function to determine a magnitude and direction of modification of individual points along the boundaries of the first structures.

8. The method of claim 7, wherein the gradient function includes a number of coefficients with individual coefficients of the number of coefficients corresponding to a different amount of modification of the boundaries of the first structures.

9. The method of claim 8, comprising determining, by the computing system, a subset of the number of coefficients to determine in relation to implementing the gradient function.

10. The method of claim 1, wherein a first portion of the second structures have a first shape and a second portion of the second structures have a second shape that is different from the first shape.

11. The method of claim 1, wherein the first efficiency and the second efficiency are determined based on a difference between a first dielectric permittivity of one or more materials comprising the first structures and the second structures and a second dielectric permittivity of a medium in which the first structures and the second structures are located.

12. The method of claim 1, wherein a first portion of the second structures have a first shape and a second portion of the second structures have a second shape that is different from the first shape.

13. The method of claim 12, wherein the first structures include first cylinders having a substantially same diameter and the second structures include second cylinders having boundaries that have an amount of deformation relative to boundaries of the first cylinders.

14. The method of claim 12, wherein one or more first dimensions of the first shape are different from one or more second dimensions of the second shape.

15. The method of claim 1, wherein dimensions of the first structures correspond to wavelengths of electromagnetic radiation incident upon the substrate.

16. A device comprising:
a substrate; and
an arrangement of structures disposed on the substrate, the structures having dimensions that correspond to wavelengths of electromagnetic radiation incident upon the substrate and the structures including:
first structures having a first shape, the first shape having one or more first segments with each first segment of the one or more first segments having at least a threshold amount of roundness; and
second structures having a second shape different from the first shape, the second shape having one or more second segments with each second segment of the one or more second segments having at least the threshold amount of roundness.

17. The device of claim 16, wherein one or more first dimensions of the first shape are different from one or more second dimensions of the second shape.

18. The device of claim 16, wherein individual structures of the arrangement of structures are disposed in individual unit cells, wherein the individual unit cells are coupled to circuitry and the circuitry provides current to the individual unit cells to cause electromagnetic radiation passing through the arrangement of structures to be modified.

19. The device of claim 16, wherein the substrate is comprised of one or more glass materials.

20. The device of claim 16, wherein the structures are comprised of one or more silicon-containing materials.

21. The device of claim 16, wherein the device is configured as a beam deflector, a metalense, or a waveguide.
